(19) United States
(12) Patent Application Publication
(10) Pub. No.: US 2026/0225894 A1
(43) Pub. Date: Aug. 6, 2026

(54) PROCESSES AND SYSTEMS FOR MAKING RENEWABLE GRAPHITE FROM BIOMASS-DERIVED SYNGAS

(71) Applicant: Carbon Technology Holdings, LLC, Oakdale, MN (US)

(72) Inventors: Edgar LOTERO, Overland Park, KS (US); Dustin SLACK, Gwinn, MI (US); Daren DAUGAARD, Newburg, MO (US); James A. MENNELL, Brighton, UT (US)

(21) Appl. No.: 19/461,897

(22) Filed: Jan. 28, 2026

Related U.S. Application Data
(60) Provisional application No. 63/752,411, filed on Jan. 31, 2025.

(51) Int. Cl. C01B 32/205

(52) U.S. Cl. CPC C01B 32/205; C01P 2006/80; C01P 2006/88

(57) ABSTRACT

A process for producing biographite from biomass comprises: converting a biomass feedstock into at least a syngas stream, wherein the syngas stream contains CO, CO₂, H₂, optionally H₂O, and optionally CH₄; providing a catalytic-metal structure comprising an aromatization catalyst that enhances formation of aromatic carbon from vapor-phase carbon-containing species; placing the catalytic-metal structure into a syngas-deposition reactor; feeding the syngas stream into the syngas-deposition reactor, wherein the syngas-deposition reactor contains less than 0.1 wt % O₂ and less than 10 wt % H₂O based on all reactor contents, wherein carbon contained in the CO deposits onto the catalytic-metal structure to form fused aromatic rings on the surface of the catalytic-metal structure, thereby forming a carbon-coated catalytic-metal structure; retrieving the carbon-coated catalytic-metal structure from the syngas-deposition reactor; recovering graphite-precursor carbon from the carbon-coated catalytic-metal structure; thermally treating the graphite-precursor carbon to generate crystalline graphite; and recovering the crystalline graphite as a biographite product.

### PRIORITY DATA

This patent application claims priority to U.S. Provisional Patent App. No. 63/752,411, filed on Jan. 31, 2025, which is hereby incorporated by reference herein.

### FIELD OF THE INVENTION

The present invention generally relates to processes and systems for making and using graphite, and graphite compositions obtained from the disclosed processes and systems.

### BACKGROUND OF THE INVENTION

Carbon is a platform element in a wide variety of industries and has a vast number of chemical, material, and fuel uses. Carbon is a good fuel to produce energy, including electricity. Carbon also has tremendous chemical value for various commodities and advanced materials, including metals, metal alloys, composites, carbon fibers, electrodes, and catalyst supports. For metal making, carbon is useful as a reactant, for reducing metal oxides to metals during processing; as a fuel, to provide heat for processing; and as a component of a metal alloy. Historically, carbon in the form of coal has been used extensively for industrial purposes. Coal is still the world's largest source of energy for electricity generation and for metal making. However, coal is believed to be the single largest contributor to the climate crisis.

Carbon can be produced, in principle, from virtually any carbonaceous material. Carbonaceous materials commonly include fossil resources such as natural gas, petroleum, coal, and lignite; and renewable resources such as lignocellulosic biomass and various carbon-rich waste materials. It is preferable to utilize renewable biomass to produce carbon-based reagents because of the rising economic, environmental, and social costs associated with fossil resources.

Biomass is a term used to describe any biologically produced matter, or biogenic matter. The chemical energy contained in biomass is derived from solar energy using the natural process of photosynthesis. Photosynthesis is the process by which plants take in carbon dioxide and water from their surroundings and, using energy from sunlight, convert them into sugars, starches, cellulose, hemicellulose, and lignin. Of all the renewable energy sources, biomass is unique in that it is, effectively, stored solar energy. Furthermore, biomass is the only renewable source of carbon.

There exist a variety of conversion technologies to turn biomass feedstocks into high-carbon materials. Pyrolysis is a process for thermal conversion of solid materials in the complete absence of oxidizing agent (air or oxygen), or with such limited supply that oxidation does not occur to any appreciable extent. Depending on process conditions and additives, biomass pyrolysis can be adjusted to produce widely varying amounts of gas, liquid, and solid. Historically, slow pyrolysis of wood has been performed in large piles, in a simple batch process, with no emissions control. Traditional charcoal-making technologies are energy-inefficient as well as highly polluting.

Carbon has several allotropes, or forms. Important allotropes of carbon include graphite, graphene, fullerenes, diamond, and amorphous carbon. Graphite and graphene have a hexagonal crystal structure; graphene is essentially a single layer of graphite. Fullerenes have a spherical, tubular, or ellipsoidal crystal structure. Diamond has a diamond cubic crystal structure with a tetrahedral geometry. Amorphous carbon is carbon that has no crystalline structure.

Graphite is a mineral composed of stacked sheets of carbon atoms. Graphite is very soft, has a low specific gravity, is relatively non-reactive, and has high electrical and thermal conductivity. Graphite is the most stable form of pure carbon under standard conditions. The carbon in graphite is sp²-hybridized. Each carbon atom is joined to three other carbon atoms by covalent bonds. The carbon atoms form layers with a hexagonal arrangement of atoms. The molecular geometry of graphite is trigonal planar with a bond angle of 120°.

Graphite is one of the most versatile non-metallic minerals in the world. Conventionally, graphite is mined from the earth. Graphite occurs naturally in igneous and metamorphic rocks, where high temperatures and pressures and immense periods of time have converted organic material included in mineral deposits into graphite. Graphite is mined in China, Bavaria, South Korea, Russia, Canada, Norway, India, Sri Lanka, Mexico, Mozambique, and Madagascar. Today, China is the world's top graphite producer.

Graphite can also be created synthetically by heating materials with high carbon content, conventionally petroleum coke or coal-tar pitch. The carbon-rich material is heated up to about 3000° C., purifying the material of contaminants and allowing the carbon to form its hexagonal sheets at chemical equilibrium. On average, production of synthetic graphite emits more greenhouse gases than mining natural graphite (source: https://news.northwestern.edu/stories/2023/02/domestic-graphite-production-green-energy-transition, accessed on Dec. 17, 2024). Graphite can also be created synthetically from syngas via Fischer-Tropsch catalytic synthesis of hydrocarbons, followed by thermal carbonization of those hydrocarbons to produce solid carbon, some of which may be graphite.

Graphite is considered a key, strategic material in the green economy including energy storage, electric vehicles, photovoltaics, and electronics. Demand for graphite is expected to outstrip supply over the next decade. Notably, there is an order of magnitude more graphite than lithium in most Li-ion batteries. For the electric-vehicle market, graphite demand is anticipated to soon exceed more than is produced globally today. Graphite usage in lithium-ion batteries, stationary batteries, lead-acid batteries, and fuel cells is expected to increase five-fold by 2050 under a scenario that limits global warming to two degrees Celsius. See Zhang et al., “Graphite Flows in the U.S.: Insights into a Key Ingredient of Energy Transition”, Environ. Sci. Technol. 2023, 57, 3402-3414, which is hereby incorporated by reference.

Graphite is used as a dry lubricant in applications where wet lubricants, such as oil, cannot be used. Graphite has been used in pencil lead since the 1600s. Graphite is used to make brake linings. Graphite is the only non-metal element that is a good conductor of electricity. As noted above, graphite electrodes are common in many types of batteries, as well as fuel cells. Graphite electrodes are used in electric arc furnaces for the steel production process. Large electrical currents are passed through the graphite electrodes, and electric arcs form between the tips of the electrodes and across the liquid steel. Natural graphite is used as molds in refractory applications that involve extremely high heat and therefore demand materials that will not melt or disintegrate under such extreme conditions. One example is a crucible used in the steel industry. Graphite is also used as a neutron moderator in nuclear reactors. Specialty graphite is used in semiconductor production. Graphite demand is also increasing for other advanced technologies including aerospace applications, ceramic armor tiles, and electro-consolidation (Zhang et al., op. cit.).

In view of the growing demand for graphite, there is a desire for more sustainable and renewable processes and systems for making graphite. In particular, there is a desire to avoid mining rocks of natural graphite, and to avoid using fossil-fuel feedstocks to make synthetic graphite.

### SUMMARY OF THE INVENTION

The present invention addresses the aforementioned needs in the art.

In some variations, the invention provides a process for producing biographite from biomass, the process comprising:
(a) converting a biomass feedstock into at least a syngas stream, wherein the syngas stream contains CO, CO₂, H₂, optionally H₂O, and optionally CH₄;
(b) providing a catalytic-metal structure comprising an aromatization catalyst that enhances formation of aromatic carbon from adsorbed vapor-phase carbon-containing species;
(c) placing the catalytic-metal structure into an internal volume of a syngas-deposition reactor;
(d) feeding the syngas stream into the syngas-deposition reactor, wherein the syngas-deposition reactor contains less than 0.1 wt % O₂ and less than 10 wt % H₂O based on all reactor contents, wherein the syngas-deposition reactor is operated at a syngas-deposition temperature from about 500° C. to about 1200° C., and wherein carbon contained in the CO deposits onto the catalytic-metal structure to form fused aromatic rings on the surface of the catalytic-metal structure, thereby forming a carbon-coated catalytic-metal structure;
(e) retrieving the carbon-coated catalytic-metal structure from the syngas-deposition reactor;
(f) recovering graphite-precursor carbon from the carbon-coated catalytic-metal structure, thereby generating a spent catalytic-metal structure;
(g) thermally treating the graphite-precursor carbon to generate crystalline graphite; and
(h) recovering the crystalline graphite as a biographite product.

In step (f), the graphite-precursor carbon is typically in the solid phase. Depending on its composition (e.g., carbon content), the graphite-precursor carbon may be in the liquid phase, or a slurry containing a solid and a liquid.

In some embodiments, step (a) utilizes biomass pyrolysis, biomass gasification, biomass plasma treatment, or a combination thereof, to generate the syngas stream.

In some embodiments, the biomass feedstock is raw biomass. The raw biomass may be selected from softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or a combination thereof, for example.

In some embodiments, the biomass feedstock is pyrolyzed biomass, which may be referred to as biochar. The pyrolyzed biomass is a pyrolyzed form of a feedstock that may be selected from softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or a combination thereof, for example.

In certain embodiments, the biomass feedstock is a mixture of raw biomass and pyrolyzed biomass, which may be independently selected from the above lists. For example, a mixture of raw hardwood chips and pyrolyzed corn stover may be used.

In some embodiments, the process further comprises subjecting the syngas stream to a water-gas shift reaction to adjust the H₂/CO ratio of the syngas stream. The water-gas shift reaction may be carried out to reduce the H₂/CO ratio of the syngas stream. The H₂/CO ratio may be selected from about 0.1 to about 1.0, from about 0.2 to about 0.7, or from about 0.2 to about 0.4, for example.

In some embodiments, the syngas-deposition reactor is operated at a syngas-deposition pressure from about 1 bar to about 50 bar. In certain embodiments, the syngas-deposition pressure is from about 1 bar to about 10 bar. In certain embodiments, such as when the syngas stream contains a substantial concentration of CH₄, the syngas-deposition pressure is from about 10 bar to about 40 bar.

In some embodiments, the aromatization catalyst contains a metal selected from Fe, Cu, Ni, Co, Mo, or a combination thereof. Alloys of any of these metals may be used in the aromatization catalyst. Alternatively, or additionally, the aromatization catalyst may contain a metal oxide selected from iron oxides, copper oxides, nickel oxides, cobalt oxides, molybdenum oxides, silicon oxides, aluminum oxides, or a combination thereof.

The aromatization catalyst may be obtained from an in situ reaction of one or more catalyst precursors, such as metal oxides and/or metal salts.

In some embodiments, the catalytic-metal structure is surface-activated prior to step (c). The catalytic-metal structure may be surface-activated using an acid wash, a base wash, or a combination thereof, for example, optionally followed by drying.

In some embodiments, the catalytic-metal structure is seeded prior to step (c).

The catalytic-metal structure may be seeded with a bioliquid film disposed on the surface of the catalytic-metal structure. The catalytic-metal structure may be seeded with an aromatics film disposed on the surface of the catalytic-metal structure.

In some embodiments, following step (f), the spent catalytic-metal structure is cleaned and then reused in step (c) as the catalytic-metal structure placed back into the syngas-deposition reactor.

In some embodiments, the syngas stream contains CH₄, and carbon contained in the CH₄ also deposits onto the catalytic-metal structure to form the fused aromatic rings on the surface of the catalytic-metal structure.

In some embodiments, carbon contained in the CO₂ also deposits (directly or indirectly) onto the catalytic-metal structure.

In some embodiments, the process further comprises purifying the spent catalytic-metal structure. Such purifying may utilize an acid wash and/or a base wash.

In some embodiments, thermally treating in step (g) uses a temperature from about 1000° C. to about 1800° C.

In some embodiments, steps (e) and (g) are conducted at different site locations.

In some embodiments, biographite product contains at least 80 wt % total carbon, at least 90 wt % total carbon, or at least 95 wt % total carbon. In certain embodiments, the biographite product contains from about 90 wt % to about 99 wt % total carbon.

In some embodiments, the biographite product contains less than 10 wt % of metals, metal alloys, metal oxides, metal carbides, metal nitrides, and/or metal hydrides. In some embodiments, the biographite product contains less than 5 wt % of metals, metal alloys, metal oxides, metal carbides, metal nitrides, and/or metal hydrides. In certain embodiments, the biographite product contains less than 1 wt % of metals, metal alloys, metal oxides, metal carbides, metal nitrides, and/or metal hydrides. In certain embodiments, the biographite product contains less than 0.5 wt %, less than 0.4 wt %, less than 0.3 wt %, less than 0.2 wt %, or less than 0.1 wt % of metals, metal alloys, metal oxides, metal carbides, metal nitrides, and/or metal hydrides.

In some embodiments, the biographite product is at least 90% renewable, at least 95% renewable, at least 99% renewable, or 100% renewable, according to a measurement of the ¹⁴C/¹²C isotopic ratio of the biographite product.

In some embodiments, the biographite product contains at least 50 wt % crystalline graphite according to spectroscopy. In certain embodiments, the biographite product contains at least 75 wt % crystalline graphite according to spectroscopy. In certain preferred embodiments, the biographite product contains at least 90 wt % crystalline graphite according to spectroscopy.

The process may be operated continuously or semi-continuously. Alternatively, the process may be operated in batch.

In some embodiments, the process further comprises fabricating an electrode containing the biographite product. The electrode may be a metal-making electrode, such as (but not limited to) an electrode utilized in electric arc furnace metal production. The electrode may be a battery electrode.

In some embodiments, steps (e) and (g) are conducted at different site locations, and the step of fabricating the electrode is conducted as the same site as step (g).

Other variations of the invention provide a process for producing biographite from renewable syngas, the process comprising:
(a) providing a renewable syngas stream containing CO, CO₂, H₂, optionally H₂O, and optionally CH₄;
(b) providing a catalytic-metal structure comprising an aromatization catalyst that enhances formation of aromatic carbon from adsorbed vapor-phase carbon-containing species;
(c) placing the catalytic-metal structure into an internal volume of a syngas-deposition reactor;
(d) feeding the syngas stream into the syngas-deposition reactor, wherein the syngas-deposition reactor contains less than 0.1 wt % O₂ and less than 10 wt % H₂O based on all reactor contents, wherein the syngas-deposition reactor is operated at a syngas-deposition temperature from about 500° C. to about 1200° C., and wherein carbon contained in the CO deposits onto the catalytic-metal structure to form fused aromatic rings on the surface of the catalytic-metal structure, thereby forming a carbon-coated catalytic-metal structure;
(e) retrieving the carbon-coated catalytic-metal structure from the syngas-deposition reactor;
(f) recovering graphite-precursor carbon from the carbon-coated catalytic-metal structure, thereby generating a spent catalytic-metal structure;
(g) thermally treating the graphite-precursor carbon to generate crystalline graphite; and
(h) recovering the crystalline graphite as a biographite product.

Other variations of the invention provide a biographite product produced by a disclosed process.

Other variations of the invention provide a system configured to carry out a disclosed process.

Some variations provide a system for producing biographite from biomass, the system comprising:
a biomass-conversion unit configured to convert a biomass feedstock into at least a syngas stream, wherein the syngas stream contains CO, CO₂, H₂, optionally H₂O, and optionally CH₄;
a syngas-deposition reactor having a catalytic-metal structure reversibly situated in an internal volume, wherein the catalytic-metal structure contains an aromatization catalyst, and wherein the syngas-deposition reactor is in syngas-flow communication with the biomass-conversion unit;
a graphite-precursor carbon recovery unit configured to (i) receive a carbon-coated form of the catalytic-metal structure from the syngas-deposition reactor following a reaction time, and (ii) separate graphite-precursor carbon from the carbon-coated form of the catalytic-metal structure;
a thermal treatment unit in flow communication with the graphite-precursor carbon recovery unit, wherein the thermal treatment unit is configured to thermally treat the graphite-precursor carbon to generate crystalline graphite; and
a product recovery unit or line configured to isolate the crystalline graphite as a biographite product.

Other variations provide a process for producing graphite-precursor carbon from biomass, the process comprising:
(a) converting a biomass feedstock into at least a syngas stream, wherein the syngas stream contains CO, CO₂, H₂, optionally H₂O, and optionally CH₄;
(b) providing a catalytic-metal structure comprising an aromatization catalyst that enhances formation of aromatic carbon from adsorbed vapor-phase carbon-containing species;
(c) placing the catalytic-metal structure into an internal volume of a syngas-deposition reactor;
(d) feeding the syngas stream into the syngas-deposition reactor, wherein the syngas-deposition reactor contains less than 0.1 wt % O₂ and less than 10 wt % H₂O based on all reactor contents, wherein the syngas-deposition reactor is operated at a syngas-deposition temperature from about 500° C. to about 1200° C., and wherein carbon contained in the CO deposits onto the catalytic-metal structure to form fused aromatic rings on the surface of the catalytic-metal structure, thereby forming a carbon-coated catalytic-metal structure;
(e) retrieving the carbon-coated catalytic-metal structure from the syngas-deposition reactor;
(f) recovering graphite-precursor carbon from the carbon-coated catalytic-metal structure, thereby generating a spent catalytic-metal structure; and
(g) capturing the graphite-precursor carbon as a carbon product.

Other variations provide a process for producing graphite-precursor carbon from renewable syngas, the process comprising:
(a) providing a renewable syngas stream containing CO, CO₂, H₂, optionally H₂O, and optionally CH₄;
(b) providing a catalytic-metal structure comprising an aromatization catalyst that enhances formation of aromatic carbon from adsorbed vapor-phase carbon-containing species;
(c) placing the catalytic-metal structure into an internal volume of a syngas-deposition reactor;
(d) feeding the syngas stream into the syngas-deposition reactor, wherein the syngas-deposition reactor contains less than 0.1 wt % O₂ and less than 10 wt % H₂O based on all reactor contents, wherein the syngas-deposition reactor is operated at a syngas-deposition temperature from about 500° C. to about 1200° C., and wherein carbon contained in the CO deposits onto the catalytic-metal structure to form fused aromatic rings on the surface of the catalytic-metal structure, thereby forming a carbon-coated catalytic-metal structure;
(e) retrieving the carbon-coated catalytic-metal structure from the syngas-deposition reactor;
(f) recovering graphite-precursor carbon from the carbon-coated catalytic-metal structure, thereby generating a spent catalytic-metal structure; and
(g) capturing the graphite-precursor carbon as a carbon product.

Other variations provide a system for producing biographite from renewable syngas, the system comprising: a system input for a renewable syngas stream, wherein the renewable syngas stream contains CO, CO₂, H₂, optionally H₂O, and optionally CH₄;
a syngas-deposition reactor having a catalytic-metal structure reversibly situated in an internal volume, wherein the catalytic-metal structure contains an aromatization catalyst, and wherein the syngas-deposition reactor is in syngas-flow communication with the system input;
a graphite-precursor carbon recovery unit configured to (i) receive a carbon-coated form of the catalytic-metal structure from the syngas-deposition reactor following a reaction time, and (ii) separate graphite-precursor carbon from the carbon-coated form of the catalytic-metal structure;
a thermal treatment unit in flow communication with the graphite-precursor carbon recovery unit, wherein the thermal treatment unit is configured to thermally treat the graphite-precursor carbon to generate crystalline graphite; and
a product recovery unit or line configured to isolate the crystalline graphite as a biographite product.

### BRIEF DESCRIPTION OF THE DRAWINGS

FIG. 1 is an exemplary block-flow diagram depicting the conversion of a biomass feedstock to a biographite product, in some embodiments of the disclosure.

FIG. 2 is an exemplary schematic diagram depicting a syngas-deposition reactor utilized in the conversion of syngas to a biographite product, in some embodiments of the disclosure.

### DETAILED DESCRIPTION OF EMBODIMENTS OF THE INVENTION

This description will enable one skilled in the art to make and use the invention, and it describes several embodiments, adaptations, variations, alternatives, and uses of the invention. These and other embodiments, features, and advantages of the present invention will become more apparent to those skilled in the art when taken with reference to the following detailed description of the invention in conjunction with the accompanying drawings.

As used in this specification and the appended claims, the singular forms “a,” “an,” and “the” include plural referents unless the context clearly indicates otherwise. Unless defined otherwise, all technical and scientific terms used herein have the same meaning as is commonly understood by one of ordinary skill in the art to which this invention belongs.

Unless otherwise indicated, all numbers expressing reaction conditions, stoichiometries, concentrations of components, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms, except in the case of Markush groups. Thus in some embodiments not otherwise explicitly recited, any instance of “comprising” may be replaced by “consisting of” or, alternatively, by “consisting essentially of.”

For purposes of an enabling technical disclosure, various explanations, hypotheses, theories, speculations, assumptions, and so on are disclosed. The present invention does not rely on any of these being in fact true. None of the explanations, hypotheses, theories, speculations, or assumptions in this detailed description shall be construed to limit the scope of the invention in any way.

For present purposes, “biogenic” is intended to mean a material (whether a feedstock, product, or intermediate) that contains an element, such as carbon, that is renewable on time scales of months, years, or decades. Non-biogenic materials may be non-renewable, or may be renewable on time scales of centuries, thousands of years, millions of years, or even longer geologic time scales. Note that a biogenic material may include a mixture of biogenic and non-biogenic sources.

For present purposes, “reagent” is intended to mean a material in its broadest sense; a reagent may be a fuel, a chemical, a material, a compound, an additive, a blend component, a solvent, and so on. A reagent is not necessarily a chemical reagent that causes or participates in a chemical reaction. A reagent may or may not be a chemical reactant; it may or may not be consumed in a reaction. A reagent may be a chemical catalyst for a particular reaction. A reagent may cause or participate in adjusting a mechanical, physical, or hydrodynamic property of a material to which the reagent may be added. For example, a reagent may be introduced to a metal to impart certain strength properties to the metal. A reagent may be a substance of sufficient purity (which, in the current context, is typically carbon purity) for use in chemical analysis or physical testing.

For present purposes, “renewable graphite” is a material that contains at least 50 wt % crystalline graphite according to spectroscopy, and that has 100% renewable carbon content based on a measurement of the ¹⁴C/¹²C isotopic ratio of the renewable graphite.

Needle coke is a carbonaceous material of defined, anisotropic structure. The carbon particles are shaped like needles because of the crystalline structure. Historically, needle coke has been used in the manufacture of graphite electrodes used in the steel industry's electric arc furnaces. Recent uses include the production of synthetic graphite for lithium-ion battery anode materials. Needle coke is also used to manufacture electrodes for electric double layer capacitors as an auxiliary source of power in electric vehicles.

Variations of the present invention are premised on the recognition that simple heating of bioliquid or biovapor feedstocks (such as at 1400-1600° C.) will not lead to the carbon quality necessary for commercial applications such as Li-ion batteries, or anodes for iron smelting. Conventional production of needle coke uses decanted heavy oil from a fluidized catalytic cracking unit in a petroleum refinery. Decanted heavy oil has a molecular structure that enables efficient conversion to needle coke. Bioliquid feedstocks, on the other hand, contain lignin polymers and other oxygen-containing polymers, which are much more difficult to convert to needle coke or other renewable biocarbon products. Biovapor feedstocks may or may not contain lignin fragments, but simple heating of biovapor with CO, CO₂, H₂, and CH₄ also does not lead to the carbon quality necessary for commercial applications such as Li-ion batteries, or anodes for iron smelting.

In some variations, the invention provides a process for producing biographite from biomass, the process comprising:
(a) converting a biomass feedstock into at least a syngas stream, wherein the syngas stream contains CO, CO₂, H₂, optionally H₂O, and optionally CH₄;
(b) providing a catalytic-metal structure comprising an aromatization catalyst that enhances formation of aromatic carbon from adsorbed vapor-phase carbon-containing species;
(c) placing the catalytic-metal structure into an internal volume of a syngas-deposition reactor;
(d) feeding the syngas stream into the syngas-deposition reactor, wherein the syngas-deposition reactor contains less than 0.1 wt % O₂ and less than 10 wt % H₂O based on all reactor contents, wherein the syngas-deposition reactor is operated at a syngas-deposition temperature from about 500° C. to about 1200° C., and wherein carbon contained in the CO deposits onto the catalytic-metal structure to form fused aromatic rings on the surface of the catalytic-metal structure, thereby forming a carbon-coated catalytic-metal structure;
(e) retrieving the carbon-coated catalytic-metal structure from the syngas-deposition reactor;
(f) recovering graphite-precursor carbon from the carbon-coated catalytic-metal structure, thereby generating a spent catalytic-metal structure;
(g) thermally treating the graphite-precursor carbon to generate crystalline graphite; and
(h) recovering the crystalline graphite as a biographite product.

In step (f), the graphite-precursor carbon is typically in the solid phase. Depending on its composition (e.g., carbon content), the graphite-precursor carbon may be in the liquid phase, or a slurry containing a solid and a liquid.

In some embodiments, step (a) utilizes biomass pyrolysis, biomass gasification, biomass plasma treatment, or a combination thereof, to generate the syngas stream.

In some embodiments, the biomass feedstock is raw biomass. The raw biomass may be selected from softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or a combination thereof, for example.

In some embodiments, the biomass feedstock is pyrolyzed biomass, which may be referred to as biochar. The pyrolyzed biomass is a pyrolyzed form of a feedstock that may be selected from softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or a combination thereof, for example.

In certain embodiments, the biomass feedstock is a mixture of raw biomass and pyrolyzed biomass, which may be independently selected from the above lists. For example, a mixture of raw hardwood chips and pyrolyzed corn stover may be used.

In some embodiments, the process further comprises subjecting the syngas stream to a water-gas shift reaction to adjust the H₂/CO ratio of the syngas stream. The water-gas shift reaction may be carried out to reduce the H₂/CO ratio of the syngas stream. The H₂/CO ratio may be selected from about 0.1 to about 1.0, from about 0.2 to about 0.7, or from about 0.2 to about 0.4, for example.

Without being limited by speculation, it is believed that two important overall chemical reactions taking place in the syngas-deposition reactor are as follows:

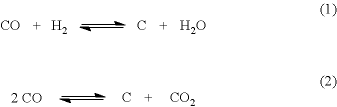

Reaction (1) is essentially CO hydrotreating, in which the H₂ pulls the O out of CO (breaking the C—O bond) to deposit solid C. Reaction (2) is the Boudouard reaction to make solid C from CO. Relying solely on the Boudouard reaction to make C from CO is normally insufficient, except at severe thermal conditions. This is why syngas, containing both CO and H₂, is desirable. H₂ also can cause reverse water-gas shift on or near the catalyst surface to turn CO₂ into CO, which is more effectively surface-adsorbed and converted to solid carbon by one or both of reactions (1) or (2). Generally, low H₂/CO ratios (e.g., 0.2-0.7) best balance the competing chemical reactions. It is also noteworthy that reaction (1) is endothermic while reaction (2) is exothermic. This provides an energetic synergy, internally utilizing heat of one reaction to help drive the other reaction.

Reactions (1) and (2) are overall reactions that are catalyzed by one or more metals (and possibly catalyst promoters) in the catalytic-metal structure. The catalyst enhances the kinetic rate of initial and/or continual solid carbon formation on the surface. The catalyst is also the substrate onto which carbon is grown in the syngas-deposition reactor. In the CVD art, the catalytic-metal structure would be referred to as a catalytic substrate. Exemplary reactions involving a catalyst can be understood with reference to an iron (Fe) catalyst, which is just one of many possible catalytic metals:

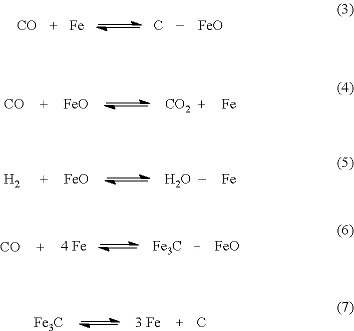

Pure iron (Fe) in the starting catalytic-metal structure reacts with CO to make FeO while depositing carbon according to reaction (3), or to make Fe₃C and FeO according to reaction (6). Iron carbide and iron oxide are reaction intermediates in the system. FeO reacts with additional CO to return pure Fe according to reaction (4), where that Fe is again available for catalysis, such as to carry out reaction (3). FeO also reacts with H₂ to make Fe according to reaction (5). Other iron oxides (e.g., Fe₂O₃) can be produced as reaction intermediates, with corresponding stoichiometries for the applicable reactions that produce and consume such intermediates. Reactions (6) and (7) generate, and then use, iron carbide (Fe₃C) to deposit solid C from Fe₃C, again returning Fe in reaction (7) that becomes available for more catalysis. Note that the sum of reactions (6) and (7) is reaction (3).

The catalytic reaction network of reactions (3)-(7) can be understood as mechanistic reactions of the overall reactions (1) and (2). In particular, adding reactions (3) and (4) gives reaction (2), while adding reactions (3) and (5) gives reaction (1)—in both cases, FeO disappears from the net chemistry, which is the definition of a catalyst. It is also possible that during deposition, surface-adsorbed CO and surface-adsorbed H₂ react according to reaction (1) to deposit carbon without FeO as a reaction intermediate. The catalytic mechanism can be complex and depends on the specific choice of catalyst, as well as reaction conditions (including at least temperature and pressure). Mechanism shifting can also occur, such as in different zones (at different temperatures) in the reactor, or following some amount of carbon growth.

Following reaction, the carbon-coated catalytic-metal structure contains at least solid carbon (C) produced, such as according to reactions (1) and/or (2) and, in the case of an iron catalyst, according to reactions (3)-(7) in some embodiments. The carbon-coated catalytic-metal structure may contain reaction intermediates, such as FeO, Fe₂O₃, or Fe₃C, that did not get completely consumed in the catalytic cycle, or that were initially supplied as catalyst precursors in excess, for example. These reaction intermediates are impurities that can be cleaned out of the graphite-precursor carbon or out of the final biographite product.

The term “graphite-precursor carbon” is referring to the material from the graphite-precursor carbon recovery unit, which separates the graphite-precursor carbon from the catalytic-metal structure. It should be understood that the carbon purity of the graphite-precursor carbon may vary. Preferably, the graphite-precursor carbon contains at least 60 wt % total carbon, more preferably at least 70 wt % total carbon, even more preferably at least 80 wt % total carbon, and most preferably at least 90 wt % total carbon. In certain embodiments, the graphite-precursor carbon contains from about 80 wt % to about 95 wt % total carbon. In various embodiments, the graphite-precursor carbon contains about, at least about, or at most about 60, 65, 70, 75, 80, 85, 90, 95, or 99 wt % total carbon, including any intervening range.

The graphite-precursor carbon may contain from 0 wt % to about 40 wt % of one or more metals, metal alloys, metal oxides, metal carbides, metal nitrides, or metal hydrides, any of which may be derived from the catalytic-metal structure. Preferably, the graphite-precursor carbon contains at most 10 wt % metals, metal alloys, metal oxides, metal carbides, metal nitrides, or metal hydrides. More preferably, the graphite-precursor carbon contains at most 5 wt % metals, metal alloys, metal oxides, metal carbides, metal nitrides, or metal hydrides. Most preferably, the graphite-precursor carbon contains at most 5 wt % metals, metal alloys, metal oxides, metal carbides, metal nitrides, or metal hydrides.

When the graphite-precursor carbon contains metal or metal derivatives from the catalytic-metal structure, then the choice of catalyst composition will dictate the specific metals (e.g., Fe, Cu, Ni, Co, and/or Mo) or metal derivatives that can be contained within the graphite-precursor carbon. For example, when an iron-based aromatization catalyst is used, the graphite-precursor carbon may contain iron, iron oxides, iron carbides, iron nitrides, or iron hydrides. When a cobalt-based aromatization catalyst is used, the graphite-precursor carbon may contain cobalt, cobalt oxides, cobalt carbides, cobalt nitrides, or cobalt hydrides, and so on.

The graphite-precursor carbon may contain a small amount of ash, such as SiO₂, but in the disclosed process, any ash contained in the biomass feedstock will not normally carry over to the syngas-deposition reactor. In the biomass-to-syngas unit, the ash will usually stay with the residual solids (e.g., pyrolysis solids or non-gasified solids), and will not be contained within the syngas vapor stream. It is possible that a small amount of ash entrainment occurs, and if not filtered out, that ash can end up being deposited onto the catalytic metal structure, either within the carbon coating or possibly as a separate layer.

In some embodiments, the syngas-deposition reactor is operated at a syngas-deposition pressure from about 1 bar to about 50 bar. In certain embodiments, the syngas-deposition pressure is from about 1 bar to about 10 bar. In certain embodiments, such as when the syngas stream contains a substantial concentration of CH₄, the syngas-deposition pressure is from about 10 bar to about 40 bar. In various embodiments, the syngas-deposition pressure is about, at least about, or at most about 0.5, 1, 1.5, 2, 2.5, 3, 4, 5, 6, 7, 8, 9, 10, 15, 20, 25, 30, 35, 40, 45, or 50 bar, including any intervening range.

In some embodiments, the aromatization catalyst contains a metal selected from Fe, Cu, Ni, Co, Mo, or a combination thereof. Alloys of any of these metals may be used in the aromatization catalyst. Alternatively, or additionally, the aromatization catalyst may contain a metal oxide selected from iron oxides, copper oxides, nickel oxides, cobalt oxides, molybdenum oxides, silicon oxides, aluminum oxides, or a combination thereof. An exemplary iron oxide catalyst is Fe₂O₃, for example.

The aromatization catalyst may be obtained from an in situ reaction of one or more catalyst precursors. Here, an in situ reaction occurs within the syngas-deposition reactor. For example, in the case of iron-based catalysis, a catalyst precursor may be an iron oxide (e.g., Fe₂O₃) or an iron-containing salt (e.g., FeSO₄). In some embodiments, the catalytic-metal structure may be formed in situ by reduction of an oxide and/or salt using feed H₂ and/or feed CO, and/or deposited C.

In the case of Fe for purposes of illustration, using iron(III) oxide (Fe₂O₃), chemical reactions to convert Fe₂O₃ catalyst precursor to Fe catalyst may include:

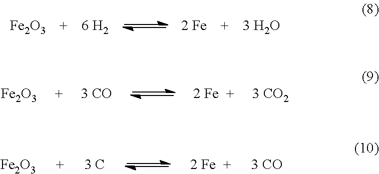

In the case of Fe for purposes of illustration, using ferrous sulfate salt (FeSO₄), a chemical reaction to convert FeSO₄ catalyst precursor to Fe catalyst may include:

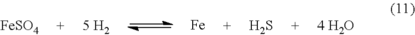

When FeSO₄ is hydrated as FeSO₄·nH₂O, additional water will be released in the reaction.

The catalyst precursor may be supported on a precursor substrate. For example, an aqueous solution of a precursor salt may be impregnated onto a precursor substrate. Following impregnation, drying may be performed to remove excess water.

Note that other aromatization catalysts can be used, such as Pt. Platinum is expensive, but with efficient recovery and reuse of catalytic-metal structures, the initial investment in platinum can be a small economic factor.

In certain embodiments, the aromatization catalyst is supported on a catalyst support, such as non-porous alumina. A porous support can be used, but carbon growth in the pores of the support can occur, and this carbon can be difficult to recover. If a catalyst support is used, it is preferably non-porous (e.g., porosity less than 5%, and preferably less than 1%).

The syngas-deposition reactor may be operated as a batch reactor, a continuous reactor, or a semi-continuous reactor.

In a batch reactor, the catalytic-metal structure and the syngas stream are both placed into the reactor, which is then sealed. The reactor is operated for a batch time such as from about 0.1 hr to about 12 hr, at a temperature from about 500° C. to about 1200° C. Carbon contained in the CO deposits onto the catalytic-metal structure to form fused aromatic rings on the surface of the catalytic-metal structure, rendering it carbon-coated. After a suitable reaction time to achieve a desired conversion or yield, the batch reactor is opened and the carbon-coated catalytic-metal structure is retrieved.

In a semi-continuous reactor, the catalytic-metal structure is initially placed in the reactor, which is then sealed. Then a syngas stream is continuously or intermittently introduced to the reactor via an inlet port, during the desired reaction time. The reactor is operated for a solid-phase residence time such as from about 0.1 hr to about 12 hr, at a temperature from about 500° C. to about 1200° C. Carbon contained in the CO deposits onto the catalytic-metal structure to form fused aromatic rings on the surface of the catalytic-metal structure, rendering it carbon-coated. Following the reaction time, the reactor is opened and the carbon-coated catalytic-metal structure is retrieved.

In a fully continuous reactor, catalytic-metal structures and syngas are constantly (or intermittently) being fed to the reactor, during the desired operation period. The reactor is operated for a solid-phase residence time such as from about 0.1 hr to about 12 hr, at a temperature from about 500° C. to about 1200° C. Carbon contained in the CO continuously or intermittently deposits onto the catalytic-metal structure to form fused aromatic rings on the surface of the catalytic-metal structure, rendering it carbon-coated. A carbon-coated catalytic-metal structure is continuously ejected from the reactor, using suitable conveying means, while maintaining a seal such that syngas does not leak to the atmosphere. This may be achieved, for example, by transferring the carbon-coated catalytic-metal structure to a reactor zone that is syngas-locked with the primary reaction chamber. A syngas lock may create an enclosed chamber with two doors that are designed to never open simultaneously, allowing materials to transition between environments with different pressures or compositions. The syngas lock acts as a controlled transition space by first equalizing the pressure before fully opening to the final environment from which the carbon-coated catalytic-metal structure is retrieved.

As noted above, the solid-phase residence time may be selected from about 0.1 hr to about 12 hr. The solid-phase residence time is the batch time for a batch reactor. For a continuous or semi-continuous reactor, the solid-phase residence time is the volume of the reactor divided by the net flow rate of any solid materials through the volume (solid materials include the catalytic-metal structure itself and any solid carbon or other solids).

In various embodiments, the solid-phase residence time is about, at least about, or at most about 0.1, 0.2, 0.3, 0.4, 0.5, 0.6, 0.7, 0.8, 0.9, 1, 1.5, 2, 2.5, 3, 3.5, 4, 5, 6, 7, 8, 9, 10, 11, or 12 hours, including any intervening range. Solid-phase residence times longer than 12 hours may be used, if desired.

The syngas-deposition reactor is a multiphase reactor since there are multiple types of solids, and a gas or vapor. There will be a vapor-phase residence time defined as the volume of the reactor divided by the net flow rate of any vapor or gas through the volume (including syngas, purge gas, vapor byproducts, etc.). The vapor-phase residence time is typically lower than the solid-phase residence time, depending on the flow pattern within the reactor as well as any gas recycle. In some embodiments, the vapor-phase residence time is selected from about 1 minute to about 30 minutes, for example. In various embodiments, the vapor-phase residence time is about, at least about, or at most 1, 1.5, 2, 2.5, 3, 3.5, 4, 5, 6, 7, 8, 9, 10, 11, 12, 13, 14, 15, 20, 25, or 30 minutes, including any intervening range. Vapor-phase residence times shorter than 1 minute (e.g., about 10 seconds), or longer than 30 minutes (e.g., about 1 hour) may be used, if desired.

Various flow patterns may be employed within the syngas-deposition reactor. There may be cocurrent flow of syngas relative to the catalytic-metal structure. Alternatively, or additionally, there may be countercurrent flow of syngas relative to the catalytic-metal structure. Alternatively, or additionally, there may be cross-current flow of syngas relative to the catalytic-metal structure. The flow regime of syngas may be plug-flow, well-mixed, or a hybrid between the two extremes. Internal recycle may be used, such that syngas is recirculated within a reactor zone or between reactor zones (back-mixing). External recycle may be used, such that unconverted syngas is reinjected into the reactor, such as at the inlet port, or via a recycle port. There may be a gas purge from the reactor, optionally with reinjection of some or all of the purge gas, to promote mixing and better heat and mass transfer, for example. Computational fluid dynamics modeling may be used to simulate the flow patterns (including heat and mass) within the syngas-deposition reactor.

In reference to carbon-coated catalytic-metal structures, the term “carbon-coated” is a term of convenience to indicate that carbon has been grown on the catalytic-metal structure. The carbon-coated catalytic-metal structures is not necessarily uniformly coated with carbon, and the carbon is not necessarily a film of carbon. For example, carbon nanostructures could be present, such as nanorods emanating from the surface of the catalytic-metal structures. Carbon spheres, cylinders, or needles could be aggregated at the surface. The thickness and porosity of the carbon coating may vary widely. In some embodiments, at the end of the reaction, the carbon thickness (on average) is larger than the thickness of the catalytic-metal structure. Carbon from multiple catalytic-metal structures may congeal, i.e. grow together into a solid mass that remains connected to the underlying catalytic-metal structures. A piece of grown carbon may disconnect from the catalytic-metal structure for some reason, such as due to carbon weight, vapor turbulence, or other reasons. There may be various types of interfaces between the catalytic-metal structure surface and the carbon—and in some cases, no interface.

The carbon-coated catalytic-metal structures may contain varying concentrations of carbon, such as from about 1 wt % to about 99 wt % carbon, on average. In various embodiments, the carbon-coated catalytic-metal structures contain about, at least about, or at most about 1, 2, 3, 4, 5, 10, 15, 20, 25, 30, 35, 40, 45, 50, 55, 60, 65, 70, 75, 80, 85, 90, 95, or 99 wt % carbon, including any intervening range, on average.

The carbon-coated catalytic-metal structures may contain varying concentrations of catalyst, such as from about 1 wt % to about 99 wt % catalyst, on average. “Catalyst” here is referring to the total weight of the catalytic-metal structure, even if a portion (e.g., catalyst support or catalyst impurities) does not formally participate in catalysis. In various embodiments, the carbon-coated catalytic-metal structures contain about, at least about, or at most about 1, 2, 3, 4, 5, 10, 15, 20, 25, 30, 35, 40, 45, 50, 55, 60, 65, 70, 75, 80, 85, 90, 95, or 99 wt % catalyst, including any intervening range, on average. As noted elsewhere, the catalyst may contain Fe, Cu, Ni, Co, and/or Mo, alloys thereof, oxides thereof, or combinations of the foregoing. As an example calculation for purposes of illustration, a carbon-coated catalytic-metal structure that contains 10 kg carbon, 5 kg iron, 1 kg iron oxide, and 1 kg iron carbide, and 3 kg alumina catalyst support means the carbon-coated catalytic-metal structure is 10/20=50 wt % carbon, and (5+1+1+3)/20=50 wt % catalyst.

In some embodiments, the catalytic-metal structure is surface-activated prior to step (c). The catalytic-metal structure may be surface-activated using an acid wash (e.g., using sulfuric acid or acetic acid), a base wash (e.g., using sodium hydroxide or ammonium hydroxide), or a combination thereof, for example, optionally followed by drying. The surface activation may cause metal leaching to create more surface sites prone to reaction. Metal-surface alloying or addition of catalyst promoters can also be used, if desired.

In some embodiments, the catalytic-metal structure is seeded prior to step (c). If surface activation is performed, typically seeding will follow that, although not necessarily. They could be combined.

In some embodiments, the catalytic-metal structure is not seeded at all. In other embodiments, seeding the catalytic-metal structure increases the graphite selectivity.

The catalytic-metal structure may be seeded with a bioliquid film disposed on the surface of the catalytic-metal structure. A bioliquid film may contain lignin, lignin derivatives (such as deoxygenated lignin), pyrolysis oil, bio-oil, tars, etc. The catalytic-metal structure may be seeded with an aromatics film disposed on the surface of the catalytic-metal structure. The aromatics film is not necessarily from biomass. For example, aromatics may include benzene, toluene, ethylbenzene, xylenes, diethylbenzenes, and the like, all of which can be obtained from crude oil or from coal, in addition to potentially being lignin derivatives. In certain embodiments, coal tars or heavy oils from petroleum are used in the aromatics film.

In some embodiments, the syngas stream contains CH₄, and carbon contained in the CH₄ also deposits onto the catalytic-metal structure to form the fused aromatic rings on the surface of the catalytic-metal structure.

In some embodiments, carbon contained in the CO₂ also deposits (directly or indirectly) onto the catalytic-metal structure. For example, CO₂ may adsorb or otherwise associate on the surface, at which water-gas shift can take place to react the CO₂ with H₂ and generate CO and H₂O. The CO, in turn, may then react in the same way as CO in the starting syngas, for example.

In some embodiments, following step (f), a spent catalytic-metal structure is cleaned and then reused in step (c) as a catalytic-metal structure placed back into the syngas-deposition reactor. In embodiments comprising purifying the spent catalytic-metal structure, such purifying may utilize an acid wash (e.g., sulfuric acid) and/or a base wash (e.g., sodium hydroxide).

It is also possible to purify (e.g., acid wash) the carbon-coated catalytic-metal structure, if desired, prior to removing the graphite-precursor carbon. The graphite-precursor carbon, after it is recovered, may also be purified if desired, as part of the graphite production unit.

The biographite product may be cleaned, such as with an acid wash, especially if there is significant metal contamination. When there are magnetic metals, such as iron, in the biographite product, a magnetic separation may be used to purify the biographite product. An electrostatic precipitator (ESP) may be used to remove metal from biographite by electrically charging the metal particles within a gas stream, causing the metal particles to be attracted to collection plates with an opposite charge. Another technique to remove metals from the biographite employs a halogen gas, such as chlorine gas (Cl₂), in which the halogen reacts with metal atoms (e.g., Co), forming volatile metal chlorides (e.g., CoCl₂) that are removed from the purified biographite.

In the graphite production unit, during step (g), the graphite-precursor carbon is thermally treated to generate crystalline graphite. In some embodiments, thermally treating in step (g) uses a temperature from about 1000° C. to about 1800° C. In various embodiments, thermally treating in step (g) uses a temperature of about, at least about, or at most about 1000° C., 1100° C., 1200° C., 1300° C., 1400° C., 1500° C., 1600° C., 1700° C., or 1800° C., including any intervening range. Even higher temperatures may be employed, such as about 1900° C., 2000° C., 2100° C., 2200° C., 2300° C., 2400° C., or 2500° C., including any intervening range.

In some embodiments, the graphite production unit is operated in a substantially inert-gas atmosphere. A substantially inert-gas atmosphere for the thermal-treatment unit may be achieved using nitrogen or argon, for example.

The relatively high temperature in the graphite production unit may be realized in a wide variety of ways. Preferably, heat is provided by an external source, rather than being generated internally within the graphite production unit by carbon oxidation, since that results in yield loss. External heat sources may include, but are not limited to, direct steam heating, indirect steam heating, direct electrical heating, indirect electrical heating, direct hot-liquid (e.g., hot oil) heating, indirect hot-liquid heating, electromagnetic radiation, electromagnetic induction, or a combination thereof.

Indirect electrical heating may use Joule heating (resistive heating) of an electrically resistive element in thermal contact with the graphite-precursor carbon. Direct electrical heating may use Joule heating of the graphite-precursor carbon itself.

Resistive heating relies on the principle of Joule heating. A high electric current is passed through the carbon material or a resistive heating element. The resistive heating element offers resistance to the flow of current, causing electrical energy to be converted into heat. The resistive heating element may be made from the biographite product, or a metal such as tungsten, or a ceramic such as SiC, or a combination thereof. Resistive heating can achieve the very high temperatures desirable for graphitization. Resistive heating furnaces (e.g., Acheson furnaces) can be scaled up for industrial production.

In some embodiments, steps (e) and (g) are conducted at different site locations. That is, the syngas-deposition reactor may be located at a first site which produces the graphite-precursor carbon. At a second site, the graphite-precursor carbon is converted to the biographite product, in these embodiments.

In some embodiments, biographite product contains at least 80 wt % total carbon, at least 90 wt % total carbon, or at least 95 wt % total carbon. In certain embodiments, the biographite product contains from about 90 wt % to about 99 wt % total carbon. In various embodiments, the biographite product contains about, at least about, or at most about 60, 65, 70, 75, 80, 85, 90, 91, 92, 93, 94, 95, 96, 97, 98, 99, 99.5, 99.9, or 100 wt % carbon, including any intervening range, on average.

The biographite product may contain from 0 wt % to about 10 wt % of one or more metals, metal alloys, metal oxides, metal carbides, metal nitrides, or metal hydrides, any of which may be derived from the catalytic-metal structure. Preferably, the biographite product contains at most 5 wt % metals, metal alloys, metal oxides, metal carbides, metal nitrides, or metal hydrides. More preferably, the biographite product contains at most 1 wt % metals, metal alloys, metal oxides, metal carbides, metal nitrides, or metal hydrides. Most preferably, the biographite product contains at most 0.5 wt % metals, metal alloys, metal oxides, metal carbides, metal nitrides, or metal hydrides. In various embodiments, the biographite product contains about, at least about, or at most about 0, 0.05, 0.1, 0.15, 0.2, 0.25, 0.3, 0.4, 0.5, 0.6, 0.7, 0.8, 0.9, 1, 1.5, 2, 2.5, 3, 4, 5, 6, 7, 8, 9, or 10 wt % of metals, metal alloys, metal oxides, metal carbides, metal nitrides, or metal hydrides. In certain embodiments, the biographite product contains less than 0.5 wt %, less than 0.4 wt %, less than 0.3 wt %, less than 0.2 wt %, or less than 0.1 wt % of metals, metal alloys, metal oxides, metal carbides, metal nitrides, and/or metal hydrides.

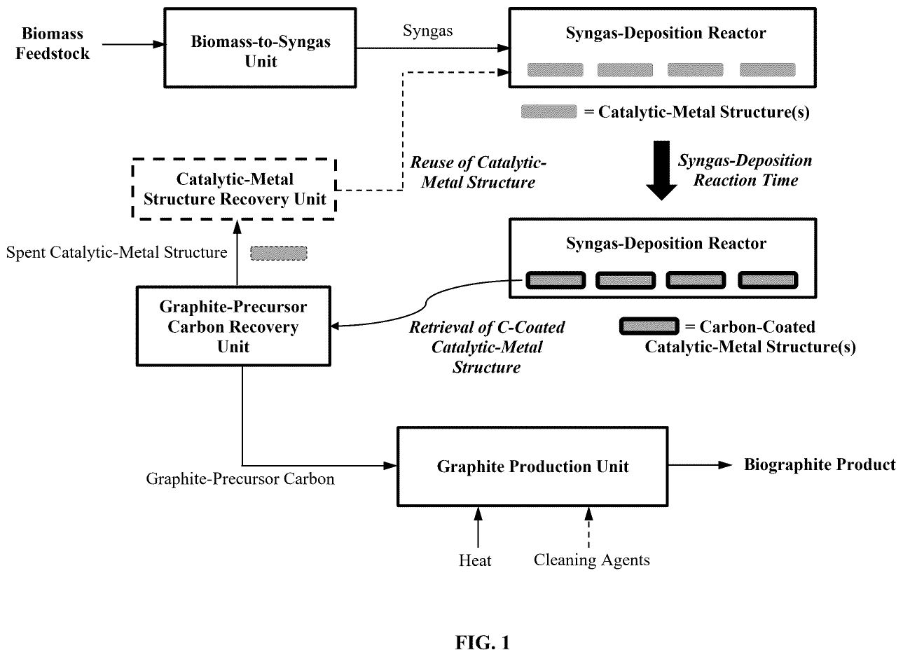

In certain embodiments for certain commercial applications, some amount of desired metal(s) is useful in the biographite product, such as when doped graphite is being made. In these embodiments, cleaning may be omitted (or modified) in the graphite production unit of FIG. 1, so that metals contained in the graphite-precursor carbon remain in the final biographite product.

Typically, the choice of catalyst composition will dictate the specific metals (e.g., Fe, Cu, Ni, Co, and/or Mo) or metal derivatives that can be contained within the biographite product. For example, when an iron-based aromatization catalyst is used, the biographite product may contain iron, iron oxides, iron carbides, iron nitrides, or iron hydrides. When a cobalt-based aromatization catalyst is used, the biographite product may contain cobalt, cobalt oxides, cobalt carbides, cobalt nitrides, or cobalt hydrides, and so on. Note, however, that other metals (not from the catalyst) may be intentionally added to the biographite product as additives-such as for doping, electrical conductivity modification, thermal conductivity modification, electrode chemistry enhancement (e.g., placement of lithium into the graphite to fabricate a lithiated graphite product), etc.

The biographite product may contain a small amount of ash, such as SiO₂. In the disclosed process, any ash contained in the biomass feedstock will not normally carry over to the syngas-deposition reactor. In the biomass-to-syngas unit, the ash will usually stay with the residual solids (e.g., pyrolysis solids or non-gasified solids), and will not be contained within the syngas vapor stream. It is possible that a small amount of ash entrainment occurs, and if not filtered out, that ash can end up being deposited onto the catalytic metal structure, either within the carbon coating or possibly as a separate layer. If that ash is contained within the carbon coating itself, the ash will likely remain in the graphite-precursor carbon unless the ash is removed in the graphite-precursor carbon recovery unit.

In various embodiments, the biographite product contains ash in a concentration of about, or at most about, 0, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, or 2 wt %, including any intervening range. The ash concentration can be determined using ASTM C561-23 “Standard Test Method for Ash in a Graphite Sample”, which is incorporated by reference.

The biographite product may be completely dry, or may have some moisture. In various embodiments, the biographite product contains moisture (water) in a concentration of about, or at most about, 0, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.5, 3, 4, 5, 6, 7, 8, 9, or 10 wt %, including any intervening range. The moisture concentration can be determined using ASTM C562-15 “Standard Test Method for Moisture in a Graphite Sample”, which is incorporated by reference.

In some embodiments, the biographite product is at least 90% renewable, at least 95% renewable, at least 99% renewable, or 100% renewable, according to a measurement of the ¹⁴C/¹²C isotopic ratio of the biographite product. The measurement of the ¹⁴C/¹²C isotopic ratio of the biographite product may utilize ASTM D6866-22 “Standard Test Methods for Determining the Biobased Content of Solid, Liquid, and Gaseous Samples Using Radiocarbon Analysis”, which is hereby incorporated by reference herein.

In some embodiments, the biographite product contains at least 50 wt % crystalline graphite according to spectroscopy. In certain embodiments, the biographite product contains at least 75 wt % crystalline graphite according to spectroscopy. In certain preferred embodiments, the biographite product contains at least 90 wt %, at least 95 wt %, or at least 99 wt % crystalline graphite according to spectroscopy. In various embodiments, the biographite product contains about, at least about, or at most about 50, 55, 60, 65, 70, 75, 80, 85, 90, 91, 92, 93, 94, 95, 96, 97, 98, 99, 99.5, or 99.9 wt % crystalline graphite according to spectroscopy.

In this specification, “spectroscopy” refers to the measurement of spectra produced when matter (in this case, a sample of biographite product) interacts with or emits electromagnetic radiation. As is known in the graphite art, there are several spectroscopic methods that may be used to determine crystallinity of carbon. In some embodiments, crystalline graphite is determined according to X-ray diffraction (XRD). In some embodiments, crystalline graphite is determined according to Raman spectroscopy, utilizing inelastic (Raman) scattering of photons. In some embodiments, crystalline graphite is determined according to combined XRD-Raman spectroscopy. In some embodiments, inductively coupled plasma (ICP) spectroscopy is used to identify and measure elements in a graphite sample by ionizing the sample with a plasma. It is also possible to use thermal methods (e.g., thermogravimetric analysis) to estimate the crystallinity of carbon. Thermal methods may be used in conjunction with spectroscopy, or may be used alone, such as with a prior calibration of crystalline graphite content according to spectroscopy or against known graphite standards.

The process may be operated continuously or semi-continuously. Alternatively, the process may be operated in batch. Distinct steps may be continuous while other steps are not. For example, conversion of biomass to a syngas stream in step (a) may use a continuous gasifier, and there may be semi-continuous supply of the syngas to the syngas-deposition reactor for production runs, which themselves may be batch or continuous.

In some embodiments, the process further comprises fabricating an electrode containing the biographite product. The electrode may be a metal-making electrode, such as (but not limited to) an electrode utilized in electric arc furnace metal production. The electrode may be a battery electrode.

In some embodiments, steps (e) and (g) are conducted at different site locations, and the step of fabricating the electrode is conducted as the same site as step (g).

FIG. 1 is an exemplary block-flow diagram depicting the conversion of a biomass feedstock to a biographite product, in some embodiments of the disclosure. In FIG. 1, a biomass feedstock is converted into syngas using a biomass-to-syngas unit. The biomass-to-syngas unit may be a gasifier or a pyrolysis reactor, for example. The syngas is fed to a syngas-deposition reactor which contains one or more catalytic-metal structures. During the syngas-deposition reaction time, there is growth of carbon on the surfaces of the catalytic-metal structures. The carbon-coated catalytic-metal structures are retrieved from the reactor and conveyed to a graphite-precursor carbon recovery unit. Essentially, the graphite-precursor carbon recovery unit splits away the surface carbon from the underlying catalytic-metal structures, with varying degrees of efficiency (yield). The separated carbon is still usually not high-quality graphite, although some graphite phase may be present. This carbon is termed graphite-precursor carbon and is conveyed to a graphite production unit, from which a biographite product is obtained. Following the split of carbon, a catalytic-metal structure is referred to as a “spent” catalytic-metal structure. The spent catalytic-metal structures may optionally be treated in a catalytic-metal structure recovery unit, such as a unit that cleans or reactivates the structures with an acid, a base, a solvent, or a combination thereof. The recovered catalytic-metal structures from the catalytic-metal structure recovery unit, or those directly from the graphite-precursor carbon recovery unit, may be reused within the syngas-deposition reactor. Such process may be repeated indefinitely, unless the catalyst becomes inactivated due to fouling or poisoning, in which case fresh catalytic-metal structures may be used.

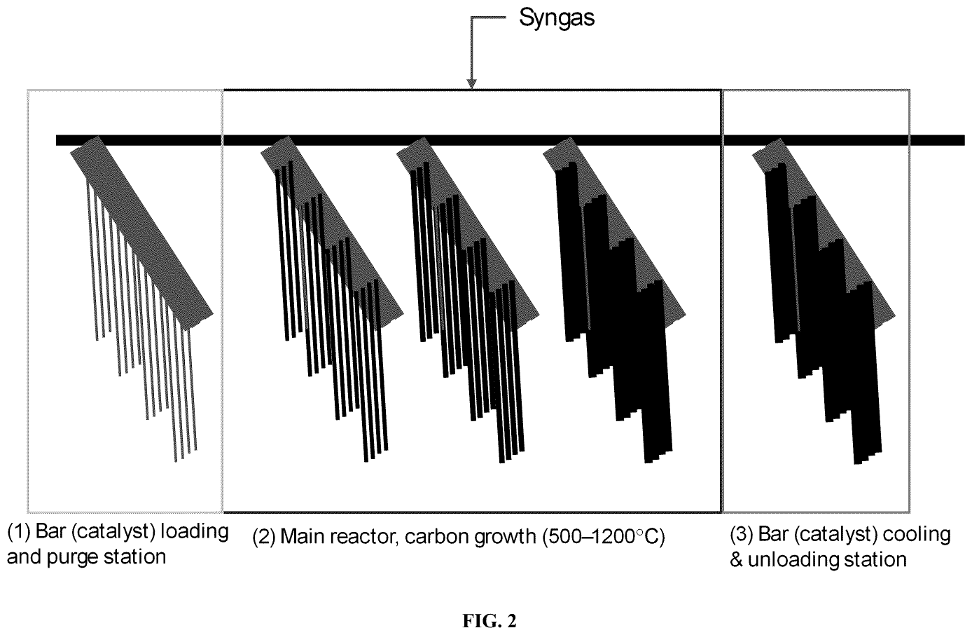

FIG. 2 is an exemplary schematic diagram depicting a syngas-deposition reactor utilized in the conversion of syngas to a biographite product, in some embodiments of the disclosure. The syngas may be derived from biomass, but not necessarily (e.g., the syngas may be obtained from CH₄ and/or CO₂). In FIG. 2, the catalytic-metal structures are in the form of bars (denoted blue in FIG. 2). The bar catalysts are loaded into the main reactor zone. The reactor is operated at a temperature from 500° C. to 120° C. for an effective time to grow carbon (denoted black in FIG. 2). Carbon growth is illustrated by increasing thicker black regions on individual catalyst bars. The carbon-coated catalytic-metal structures are then cooled and unloaded from the main reactor zone. The retrieved carbon-coated catalytic-metal structures may then be further processed as depicted in FIG. 1, such as being conveyed to a graphite-precursor carbon recovery unit. Conceptually, there may be a market (commercial use) for the carbon-coated catalytic-metal structures, in which case they may be sold rather than further processed.

The syngas-deposition reactor may be a chemical-vapor-deposition (CVD) reactor. Exemplary CVD reactors include cold-wall CVD reactors, hot-wall CVD reactors, plasma-enhanced CVD reactors, atmospheric-pressure CVD reactors, low-pressure CVD reactors, and high-pressure CVD reactors. In cold-wall CVD reactors, the catalytic-metal structures are heated, allowing for control of deposition and minimizing unwanted carbon deposition on the chamber walls. In hot-wall CVD reactors, the catalytic-metal structures and the reactor walls are both heated, leading to uniform temperature across the chamber. This can result in carbon deposition on the walls of the reactor, necessitating occasional clean-out of the reactor. When the catalytic-metal structures are heated directly, the heating mechanism may be thermal conduction from a heat source, electrical-resistivity heating, or another heating mechanism.

In some embodiments, the catalytic-metal structures are not directly heated. The desired reaction temperature is instead achieved using hot syngas and/or reactor heating, for example.

In certain embodiments, hot syngas enters the reactor chamber. The heat from the syngas is partially transferred to the catalytic-metal structures, heating them up. The local temperature at the surface of a catalytic-metal structure dictates the kinetic rate of the catalytic carbon growth. The local temperature will be governed not only by the syngas feed temperature and the starting catalyst temperature, but also by the enthalpies of reactions taking place.

In certain embodiments, the reactor is externally heated, such as via steam heating, hot-oil heating, electrical heating, heating from external combustion, or a combination thereof. Internal heating elements may be included within the reactor, if desired. The walls of the reactor may be configured for Joule heating, essentially turning the reactor into an oven.

While some embodiments employ certain principles of chemical vapor deposition and/or physical vapor deposition, the disclosed technology is not intended to fabricate single-crystalline domains of graphene on a dielectric substrate, for electronics or optoelectronics.

The graphite-precursor carbon recovery may be a dry process or a wet process. In a dry process, the graphite-precursor carbon recovery unit may be a mechanical mill that physically removes the graphite-precursor carbon from the catalytic-metal structures. The physical removal may utilize mechanical mixing following by collection of carbon and catalytic-metal structures. A refining disk may be used to physically remove carbon from the catalytic-metal structures. A centrifuge may be used to separate carbon and catalyst based on density. A filter may be used to separate carbon and catalyst based on particle size (typically the carbon particles are much smaller than the catalytic-metal structures). In a wet process, a slurry may be formed, following by centrifugation or filtration. A solvent (e.g., HF) may be used to dissolve carbon from the carbon-coated catalytic-metal structure.

The yield of carbon from the graphite-precursor carbon recovery unit is preferably at least 50%, more preferably at least 80%, even more preferably at least 90%, and most preferably at least 95%. The yield is calculated as recovered graphite-precursor carbon divided by total carbon present in the carbon-coated catalytic-metal structures (excluding any carbon in the catalyst itself, in the case of metal carbides or carbon-containing alloys).

Preferably the geometry of the catalytic-metal structure remains intact, for beneficial reuse. However, in certain embodiments, the entire carbon-coated catalytic-metal structure is mechanically refined (e.g., milled) into particles of carbon and particles of catalyst. The carbon and catalyst may be separated, and the carbon fed to the graphite production unit. The catalyst particles may be used to fabricate catalyst-metal structures, such as via melting and solidification into the desired structures (e.g., bars).

The syngas-deposition reactor preferably contains less than 0.1 wt % O₂, to avoid oxidation of carbon. In some embodiments, the syngas-deposition reactor contains less than 0.01 wt % 02, or less than 0.001 wt % 02, such as no detectible O₂. These oxygen concentrations are based on all reactor contents, including catalyst.

In some embodiments, the syngas-deposition reactor is operated in a substantially inert-gas atmosphere. A substantially inert-gas atmosphere for the syngas-deposition reactor may be achieved using nitrogen or argon, for example.

The syngas-deposition reactor preferably contains less than 10 wt % H₂O, to avoid steam reforming of carbon. In some embodiments, the syngas-deposition reactor contains less than 9 wt % H₂O, less than 8 wt % H₂O, less than 7 wt % H₂O, less than 6 wt % H₂O, less than 5 wt % H₂O, less than 4 wt % H₂O, less than 3 wt % H₂O, less than 2 wt % H₂O, less than 1 wt % H₂O, less than 0.5 wt % H₂O, or less than 0.1 wt % H₂O. These water concentrations are based on all reactor contents, including catalyst.

Other variations of the invention provide a process for producing biographite from renewable syngas, the process comprising:
(a) providing a renewable syngas stream containing CO, CO₂, H₂, optionally H₂O, and optionally CH₄;
(b) providing a catalytic-metal structure comprising an aromatization catalyst that enhances formation of aromatic carbon from adsorbed vapor-phase carbon-containing species;
(c) placing the catalytic-metal structure into an internal volume of a syngas-deposition reactor;
(d) feeding the syngas stream into the syngas-deposition reactor, wherein the syngas-deposition reactor contains less than 0.1 wt % O₂ and less than 10 wt % H₂O based on all reactor contents, wherein the syngas-deposition reactor is operated at a syngas-deposition temperature from about 500° C. to about 1200° C., and wherein carbon contained in the CO deposits onto the catalytic-metal structure to form fused aromatic rings on the surface of the catalytic-metal structure, thereby forming a carbon-coated catalytic-metal structure;
(e) retrieving the carbon-coated catalytic-metal structure from the syngas-deposition reactor;
(f) recovering graphite-precursor carbon from the carbon-coated catalytic-metal structure, thereby generating a spent catalytic-metal structure;
(g) thermally treating the graphite-precursor carbon to generate crystalline graphite; and
(h) recovering the crystalline graphite as a biographite product.

Other variations of the invention provide a biographite product produced by a disclosed process.

Other variations of the invention provide a system configured to carry out a disclosed process.

Some variations provide a system for producing biographite from biomass, the system comprising:
a biomass-conversion unit configured to convert a biomass feedstock into at least a syngas stream, wherein the syngas stream contains CO, CO₂, H₂, optionally H₂O, and optionally CH₄;
a syngas-deposition reactor having a catalytic-metal structure reversibly situated in an internal volume, wherein the catalytic-metal structure contains an aromatization catalyst, and wherein the syngas-deposition reactor is in syngas-flow communication with the biomass-conversion unit;
a graphite-precursor carbon recovery unit configured to (i) receive a carbon-coated form of the catalytic-metal structure from the syngas-deposition reactor following a reaction time, and (ii) separate graphite-precursor carbon from the carbon-coated form of the catalytic-metal structure;
a thermal treatment unit in flow communication with the graphite-precursor carbon recovery unit, wherein the thermal treatment unit is configured to thermally treat the graphite-precursor carbon to generate crystalline graphite; and
a product recovery unit or line configured to isolate the crystalline graphite as a biographite product.

Other variations provide a process for producing graphite-precursor carbon from biomass, the process comprising:
(a) converting a biomass feedstock into at least a syngas stream, wherein the syngas stream contains CO, CO₂, H₂, optionally H₂O, and optionally CH₄;
(b) providing a catalytic-metal structure comprising an aromatization catalyst that enhances formation of aromatic carbon from adsorbed vapor-phase carbon-containing species;
(c) placing the catalytic-metal structure into an internal volume of a syngas-deposition reactor;
(d) feeding the syngas stream into the syngas-deposition reactor, wherein the syngas-deposition reactor contains less than 0.1 wt % O₂ and less than 10 wt % H₂O based on all reactor contents, wherein the syngas-deposition reactor is operated at a syngas-deposition temperature from about 500° C. to about 1200° C., and wherein carbon contained in the CO deposits onto the catalytic-metal structure to form fused aromatic rings on the surface of the catalytic-metal structure, thereby forming a carbon-coated catalytic-metal structure;
(e) retrieving the carbon-coated catalytic-metal structure from the syngas-deposition reactor;
(f) recovering graphite-precursor carbon from the carbon-coated catalytic-metal structure, thereby generating a spent catalytic-metal structure; and
(g) capturing the graphite-precursor carbon as a carbon product.

Some processes are premised on the recognition that for certain applications not requiring high-quality graphite, the graphite-precursor carbon need not be calcined. Some variations provide a process for producing graphite-precursor carbon from renewable syngas, the process comprising:
(a) providing a renewable syngas stream containing CO, CO₂, H₂, optionally H₂O, and optionally CH₄;
(b) providing a catalytic-metal structure comprising an aromatization catalyst that enhances formation of aromatic carbon from adsorbed vapor-phase carbon-containing species;
(c) placing the catalytic-metal structure into an internal volume of a syngas-deposition reactor;
(d) feeding the syngas stream into the syngas-deposition reactor, wherein the syngas-deposition reactor contains less than 0.1 wt % O₂ and less than 10 wt % H₂O based on all reactor contents, wherein the syngas-deposition reactor is operated at a syngas-deposition temperature from about 500° C. to about 1200° C., and wherein carbon contained in the CO deposits onto the catalytic-metal structure to form fused aromatic rings on the surface of the catalytic-metal structure, thereby forming a carbon-coated catalytic-metal structure;
(e) retrieving the carbon-coated catalytic-metal structure from the syngas-deposition reactor;
(f) recovering graphite-precursor carbon from the carbon-coated catalytic-metal structure, thereby generating a spent catalytic-metal structure; and
(g) capturing the graphite-precursor carbon as a carbon product.

Other variations provide a system for producing biographite from renewable syngas, the system comprising:
a system input for a renewable syngas stream, wherein the renewable syngas stream contains CO, CO₂, H₂, optionally H₂O, and optionally CH₄;
a syngas-deposition reactor having a catalytic-metal structure reversibly situated in an internal volume, wherein the catalytic-metal structure contains an aromatization catalyst, and wherein the syngas-deposition reactor is in syngas-flow communication with the system input;
a graphite-precursor carbon recovery unit configured to (i) receive a carbon-coated form of the catalytic-metal structure from the syngas-deposition reactor following a reaction time, and (ii) separate graphite-precursor carbon from the carbon-coated form of the catalytic-metal structure;
a thermal treatment unit in flow communication with the graphite-precursor carbon recovery unit, wherein the thermal treatment unit is configured to thermally treat the graphite-precursor carbon to generate crystalline graphite; and
a product recovery unit or line configured to isolate the crystalline graphite as a biographite product.

Renewable syngas can be produced from a wide variety of renewable sources, including (but not limited to) biomass, lignin, biogas, and carbon dioxide (e.g., fermentation-derived CO₂),

As noted earlier, the catalytic-metal structure may be seeded with a bioliquid film disposed on the surface of the catalytic-metal structure. The bioliquid film may contain a bioliquid feedstock. A “bioliquid feedstock” means a liquid-phase feed material that is derived from biomass. The bioliquid feedstock contains fully renewable carbon according to a measurement of the ¹⁴C/¹²C isotopic ratio of the bioliquid feedstock.

In some embodiments, the bioliquid feedstock is obtained from condensing and optionally fractionating a pyrolysis vapor from biomass pyrolysis. Condensing the pyrolysis vapor is performed using a condenser system, which may employ a single-stage condenser or a multiple-stage condenser. When fractionation is employed, the fractionation may be applied to the pyrolysis vapor, the condensed liquid, or both of these. Fractionation may separate according to molecular weight, boiling point, polarity, water content, or a combination thereof.

In some embodiments, the condenser system is a thermally controlled multiple-stage separation system configured to capture multiple liquid fractions. The multiple liquid fractions may be separated according to molecular weight, boiling point, polarity, water content, or a combination thereof, for example. The condensate may include at least two of the multiple liquid fractions in recombined form. In certain embodiments, at least one of the multiple liquid fractions is recovered as a light co-product that does not form part of the condensate.

In some embodiments, the bioliquid feedstock is an external feedstock from a variety of sources. The bioliquid feedstock may be obtained from an adjacent biorefinery, or may be obtained commercially and transported to the process site. The bioliquid feedstock may be a crude bioliquid or a purified bioliquid. The bioliquid feedstock may contain lignin, lignin derivatives, sugars, sugar derivatives, and sugar degradation products (e.g., furfural), for example. In preferred embodiments, the bioliquid feedstock contains aromatic groups, since aromatics are typically more carbon-rich than olefins, alkanes, alcohols, and organic acids. In some embodiments, the bioliquid feedstock contains polyphenols.

When the bioliquid feedstock is obtained from an external source, the external source may be a site that carries out any of the processes disclosed herein. The external source may be a commercial chemical company. The external source may be a biorefinery that produces a lignin or lignin-derived co-product. The lignin may be obtained from a biorefinery plant that uses pyrolysis, gasification, acid hydrolysis, enzymatic hydrolysis, chemical pulping, mechanical pulping, thermochemical pulping, or other process. Another external source of a bioliquid feedstock may be a food or nutraceutical manufacturing plant, such as one processing blueberries, plums, cherries, apples, strawberries, black currants, black olives, dark chocolate, black tea, coffee, hazelnuts, or pecans, all of which are relatively rich in polyphenols. Another external source of a polyphenolic material may be a natural-dye manufacturing plant.

The bioliquid feedstock may contain, on a dry basis, from about 20 wt % to about 90 wt %, such as from about 30 wt % to about 75 wt %, or from about 40 wt % to about 60 wt % carbon. The bioliquid feedstock may be water-free or may contain water in a concentration from about 0.1 wt % to about 50 wt %, such as from about 1 wt % to about 20 wt % water, for example.

The process may further comprise fabricating an electrode containing the biographite product. The electrode may be a metal-making electrode, such as a large electrode utilized in electric arc furnace iron or steel production. The electrode may be a battery electrode. Other types of electrodes are possible, such as fuel cell electrodes or electrolysis electrodes, among many other electrode applications.

The process may further comprise fabricating an object, other than an electrode, from the biographite product. The object may be a structural object (e.g., an engineered element), since graphite has good mechanical properties for some applications. The object may be a pellet, such as for metal-making (e.g., to replace metallurgical coke). The object may be formed for coke replacement in any commercial application of traditional coke or petroleum coke.

The biographite product may contain at least 80 wt % total carbon, at least 90 wt % total carbon, or at least 95 wt % total carbon. In some embodiments, the biographite product contains from about 90 wt % to about 99 wt % total carbon. In various embodiments, the biographite contains about, or at least about, 80, 81, 82, 83, 84, 85, 86, 87, 88, 89, 90, 91, 92, 93, 94, 95, 96, 97, 98, or 99 wt %, including any intervening range.

The biographite product is preferably a renewable biographite product, according to a measurement of the ¹⁴C/¹²C isotopic ratio. The total carbon in the biographite product is preferably at least 50% renewable as determined from a measurement of the ¹⁴C/¹²C isotopic ratio of the total carbon. More preferably, the total carbon in the biographite product is at least 75% renewable as determined from a measurement of the ¹⁴C/¹²C isotopic ratio of the total carbon. Most preferably, the total carbon in the biographite product is at least 90% renewable as determined from a measurement of the ¹⁴C/¹²C isotopic ratio of the total carbon. In various embodiments, the total carbon in the biographite product is about, or at least about 50%, 55%, 60%, 65%, 70%, 75%, 80%, 81%, 82%, 83%, 84%, 85%, 86%, 87%, 88%, 89%, 90%, 91%, 92%, 93%, 94%, 95%, 96%, 97%, 98%, 99%, 99.5%, 99.9% renewable as determined from a measurement of the ¹⁴C/¹²C isotopic ratio of the total carbon. The measurement of the ¹⁴C/¹²C isotopic ratio of the biographite product may utilize ASTM D6866, which is hereby incorporated by reference herein.

The biographite product may contain at least 50 wt %, at least 75 wt %, or at least 90 wt % crystalline graphite according to spectroscopy (e.g., XRD or Raman spectroscopy). These percentages are based on total weight of the biographite product, not just the carbon content. In various embodiments, the biographite product contains about, or at least about, 50, 55, 60, 65, 70, 75, 80, 85, 95, or 95 wt % crystalline graphite according to spectroscopy.

On the basis of carbon content only, the total carbon contained in the biographite product may be at least 75 wt %, at least 90 wt %, at least 95 wt %, or at least 99 wt % crystalline graphite according to spectroscopy. In various embodiments, the total carbon contained in the biographite product is about, or at least about, 75, 80, 85, 90, 95, or 99 wt % crystalline graphite according to spectroscopy.

The biographite product disclosed herein may be utilized in the production of a metal product. A metal product may include one or more metals, such as iron, copper, nickel, magnesium, manganese, aluminum, tin, zinc, cobalt, chromium, tungsten, molybdenum, titanium, gold, silver, lead, silicon, lithium, boron, zirconium, vanadium, platinum, palladium, rhodium, gallium, germanium, indium, bismuth, or combinations or alloys thereof. For this disclosure, silicon is considered to be a metal.

Some embodiments provide an electrode material comprising the disclosed biographite product. Some embodiments provide an electrode containing the electrode material. The electrode may be a battery electrode or a fuel cell electrode, for example. The electrode may be an electric arc furnace electrode, such as for production of iron, steel, or another metal or metal alloy. Graphite electrodes are an essential part of the electric arc furnace (EAF) steel production process and comprise a significant portion of cost, since graphite electrodes are typically consumed every 8-12 hours in continuous EAF-based steel production.

The electrode may be used in aluminum production. Aluminum is usually produced electrolytically by using anodes and cathodes. Alumina (Al₂O₃) powder is dissolved in a molten bath of sodium aluminum fluoride. Electrical current is passed between carbon anodes and a carbon cathode in the cell, reducing alumina to aluminum (Al) metal that deposits on the cathode surface. High-purity Al is recovered from the carbon cathode. Carbon anodes are consumed in the process, generating CO₂ gas (the oxygen content of that CO₂ is from the oxygen atoms in Al₂O₃). Note that the CO₂ gas contains renewable carbon when the cathode utilizes the biographite product. In aluminum production, the biographite product disclosed herein may be used as the cathode, anode, or both.

Various uses of the biographite product in electrodes include applications in batteries, fuel cells, capacitors, and other energy-storage or energy-delivery devices. In a lithium-ion battery, the biographite product may be used on the anode side to intercalate lithium within the graphite crystal lattice or between graphene layers of the graphite.

Additional embodiments, variations, options, and features will now be further described, without limitation of the claimed invention.

Some embodiments utilize a biomass-containing feedstock for the production of the syngas. For example, a biomass-containing feedstock may be subjected to biomass pyrolysis to generate biocarbon, a pyrolysis vapor, and a non-condensable gas. Syngas may be obtained from the pyrolysis vapor (e.g., via steam-reforming reactions of vapor species), from the non-condensable gas (e.g., from direct separation of CO and/H₂, or from water-gas shift), and/or from the biocarbon (e.g., via gasification).

In some embodiments, the biomass-containing feedstock is selected from softwood chips, hardwood chips, timber harvesting residue, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or a combination thereof.

When a bioliquid film is utilized for seeding the catalyst, the bioliquid may be obtained from a condenser system configured for condensing at least a portion of pyrolysis vapor from biomass pyrolysis. The condenser system may be a thermally controlled multiple-stage separation system. In various embodiments, the thermally controlled multiple-stage separation system includes one or more filters, absorption beds with solid media, absorption beds with liquid media, adsorption beds with solid media, dry scrubbers, wet scrubbers, Venturi scrubbers, centrifuges, cyclones, quench units, reactive condensers, distillation columns, reactive-distillation columns, evaporators, reactive evaporators, heat exchangers, fan separators, electrostatic precipitators, demisters, or a combination thereof. The thermally controlled multiple-stage separation system may be configured for generating a liquid condensate and a non-condensable gas from the incoming vapor.

In some embodiments, the thermally controlled multiple-stage separation system includes a cyclone unit configured for separating solid biocarbon-containing material from the incoming vapor, which may be biomass pyrolysis vapor.

In some embodiments, a quench unit is configured for exposing the incoming vapor to water, to generate liquid condensate.

In some embodiments, the thermally controlled multiple-stage separation system includes a demister unit configured to recover residual liquid from incoming vapor. The residual liquid is optionally combined with the liquid condensate (condensed bioliquid).

In some embodiments, the thermally controlled multiple-stage separation system is configured to capture multiple liquid fractions. The multiple liquid fractions may be separated according to molecular weight, boiling point, polarity, water content, or a combination thereof, for example. The liquid condensate may include at least two of the multiple liquid fractions in recombined form. In certain embodiments, at least one of the multiple liquid fractions is recovered as a light co-product that does not form part of the liquid condensate.

The condensed bioliquid may contain a polyphenolic material. In some embodiments, the polyphenolic material contains from about 20 wt % to about 80 wt % fixed carbon. In certain embodiments, the polyphenolic material contains from about 40 wt % to about 60 wt % fixed carbon. In various embodiments, the polyphenolic material contains about, at least about, or at most about 20, 25, 30, 35, 40, 45, 50, 55, 60, 65, 70, 75, or 80 wt % fixed carbon, including any intervening range.

In some embodiments, the polyphenolic material has a weight-average molecular weight MW from about 75 g/mol to about 50,000 g/mol. In certain embodiments, the polyphenolic material has a MW from about 75 g/mol to about 1,000 g/mol. In certain embodiments, the polyphenolic material has a MW from about 1,000 g/mol to about 50,000 g/mol. In various embodiments, the polyphenolic material has a MW of about, at least about, or at most about 100, 200, 300, 400, 500, 1,000, 1,500, 2,000, 2,500, 3,000, 4,000, 5,000, 10,000, 15,000, 20,000, 25,000, 30,000, 35,000, 40,000, 45,000, or 50,000 g/mol, including any intervening range. It is believed that the polyphenolic material can have a high MW due to polycondensation reactions that are thermodynamically and kinetically enhanced by the removal of water, leading to large number of monomer units within the polymer chain.

In some embodiments, the polyphenolic material has a viscosity at 25° C. from about 1 cP to about 1000 cP. In certain embodiments, the polyphenolic material has a viscosity at 25° C. from about 10 cP to about 500 cP. In various embodiments, the polyphenolic material has a viscosity at 25° C. of about, or at least about, 1, 2, 3, 4, 5, 10, 15, 20, 25, 50, 75, 100, 150, 200, 250, 300, 400, 500, 600, 700, 800, 900, or 1000 cP.

In some embodiments, the polyphenolic material contains from about 1 wt % to about 60 wt % water. This water content refers to bulk free water, as well as adsorbed water (H₂O), but not potential formation of water from —H and —OH content in the polyphenolic material. In certain embodiments, the polyphenolic material contains from about 5 wt % to about 25 wt % water. In various embodiments, the polyphenolic material contains about, at least about, or at most about 0.1, 0.5, 1, 2, 3, 4, 5, 6, 7, 8, 9, 10, 15, 2025, 30, 35, 40, 45, 50, 55, 60, 65, or 70 wt % water, including any intervening range. Certain embodiments utilize a polyphenolic material that is a relatively dry condensate fraction. Such polyphenolic material may contain about 5 wt % water or less, about 4 wt % water or less, about 3 wt % water or less, about 2 wt % water or less, or about 1 wt % water or less. In principle, a polyphenolic material may be recovered that contains essentially no water, such as by using molecular sieves.

In some embodiments, a densification unit is downstream of the graphite production unit (or part of such unit) to densify the biographite. The densification unit may be selected from an extruder, a briquetter, a pellet mill, or a combination thereof, for example. In some embodiments, the densification unit is an extruder, such as a single-screw extruder or a twin-screw extruder.

The densification unit may be operated at a densification temperature greater than 100° C., such as at least 150° C. or at least 200° C. In various embodiments, the densification temperature is about, at least about, or at most about 100° C., 110° C., 120° C., 130° C., 140° C., 150° C., 160° C., 170° C., 180° C., 190° C., 200° C., 210° C., 220° C., 230° C., 240° C., 250° C., 260° C., 270° C., 280° C., 290° C., or 300° C., including any intervening range.

The densification unit may be operated at a densification pressure of about, at least about, or at most about 1 bar, 2 bar, 3 bar, 4 bar, 5 bar, 10 bar, 15 bar, 20 bar, 25 bar, 30 bar, 35 bar, 40 bar, 45 bar, or 50 bar, including any intervening range.

The densification unit may be operated at a densification time of about, at least about, or at most about 1 minute, 5 minutes, 10 minutes, 15 minutes, 30 minutes, or 60 minutes, including any intervening range.

In some embodiments, the biographite product has a moisture content from 0 wt % to about 10 wt % water. In certain embodiments, the biographite product has a moisture content from 0 wt % to about 5 wt % water, or from 0 wt % to about 2 wt % water, or from 0 wt % to about 1 wt % water. In certain embodiments, the biographite product has a moisture content from about 1 wt % to about 2 wt %. In various embodiments, the biographite product has a moisture content of about, or at most about, 0.01, 0.05, 0.1, 0.2, 0.5, 1, 1.5, 2, 2.5, 3, 4, 5, 6, 7, 8, 9, or 10 wt %, including any intervening range.

In some embodiments, the biographite product has an ash content from 1 wt % to about 5 wt % total ash. In certain embodiments, the biographite product has an ash content of about, or at most about, 0.1, 0.5, 1, 2, 3, 4, 5, 6, 7, 8, 9, or 10 wt % ash, including any intervening range.

The biographite product may be recovered in various forms, such as powder, particulates, pellets, briquettes, rods, sheets, or random geometries.

In some embodiments, the biographite product is characterized by a bulk density of at least about 40 lb/ft³. In certain embodiments, the biographite product is characterized by a bulk density of at least about 50 lb/ft³. In various embodiments, the biographite product is characterized by a bulk density of about, or at least about, 40, 50, 60, 70, 80, 90, or 100 lb/ft³, including any intervening range.

In some embodiments, the biographite product is subjected to milling. The milling may utilize a mechanical-treatment apparatus selected from a hammer mill, an extruder, an attrition mill, a disc mill, a pin mill, a ball mill, a cone crusher, a jaw crusher, or a combination thereof.

In some embodiments, the biographite product is blended with an additive. Blending may utilize a relatively simple apparatus selected from a tumbler, a convective blender, a hopper blender, a fluidization mixer, or a combination thereof. Alternatively, or additionally, blending may utilize a mechanical-treatment apparatus selected from a hammer mill, an extruder, an attrition mill, a disc mill, a pin mill, a ball mill, a cone crusher, a jaw crusher, or a combination thereof.

When pellets of biographite product are desired, a pelletization unit is employed either downstream of the graphite production unit, or that unit is configured to fabricate pellets. The pelletization unit may be selected from an extruder, a ring die pellet mill, a flat die pellet mill, a roll compactor, a roll briquetter, a wet agglomeration mill, a dry agglomeration mill, or a combination thereof.

When the biographite product is in the form of pellets, for some applications, mechanical durability is important. In some embodiments, the biographite product is in the form of pellets characterized by a pellet compressive strength at 25° C. of at least about 100 lb_{f}/in². In certain embodiments, the pellets are characterized by a pellet compressive strength at 25° C. of at least about 200 lb_{f}/in². In various embodiments, the pellets are characterized by a pellet compressive strength at 25° C. of about, or at least about, 50, 75, 100, 125, 150, 175, 200, 225, 250, 275, or 300 lb_{f}/in², including any intervening range. The units of lb_{f}/in² (psi) are pound-force per square inch. The pellet compressive strength is calculated as compression force at pellet breakage divided by lateral area of the pellet. The lateral area of the pellet is the area along the length of the pellet that is exposed to the compressive force, and not counting the pellet sides that are not exposed to the compressive force. In the case of a perfectly spherical pellet, the lateral area is the sphere surface area. In the case of a cylindrical pellet, the lateral area is the area along the length of the cylinder, and does not include the area at the two ends of the cylinder. The pellet compressive strength may be measured using a laboratory tensile and compression load tester, for example. Pellet breakage is also known as pellet rupture or pellet crushing and may be automatically detected by the laboratory tensile and compression load tester.

The pellet compressive strength may also be measured after thermal exposure, which can be important to understand the mechanical durability of the biographite pellet in high-temperature use. For example, the pellet compressive strength may also be measured after thermal exposure at 900° C. for 20 minutes in a low-oxygen environment. The pellet compressive strength after thermal exposure may be measured using a laboratory tensile and compression load tester, for example, after the test sample has cooled back down to room temperature (about 25° C.). In some embodiments, the pellet compressive strength after 20 minutes at 900° C. is at least about 30 lb_{f}/in², preferably at least about 60 lb_{f}/in², measured after cooling back down to 25° C. In various embodiments, the pellet compressive strength after 20 minutes at 900° C. is about, or at least about 10, 20, 30, 40, 50, 60, 70, 80, or 90 lb_{f}/in², including any intervening ranges.

In some embodiments of a biographite pellet, the pellet has a pellet shape selected from a sphere, a cylinder, a cube, an octagon, a hexagon, a honeycomb, an oval, a column, a bar, a pillow, a lentil, a random granular, or a combination thereof.

In some embodiments of a biographite pellet, the pellet has a pellet size selected from about 1 mm to about 10 cm, calculated as effective diameter of the biocarbon pellet. In various embodiments, the biographite pellet has an effective diameter of about, at least about, or at most about 1 mm, 2 mm, 3 mm, 4 mm, 5 mm, 6 mm, 7 mm, 8 mm, 9 mm, 10 mm, 15 mm, 2 cm, 3 cm, 4 cm, 5 cm, 6 cm, 7 cm, 8 cm, 9 cm, or 10 cm, including any intervening range.

In some embodiments of a biographite pellet, the biographite pellet is characterized by a low odor according to ASTM D1296. Another relevant odor test may be employed, including a simple qualitative test for odor. An olfactometer may be utilized to measure odor.

In some embodiments of a biographite pellet, the pellet is characterized as non-self-heating when subjected to a self-heating test according to Manual of Tests and Criteria, Seventh revised edition 2019, United Nations, Page 375, 33.4.6 Test N. 4: “Test method for self-heating substances”.

In some embodiments of a biographite pellet, a pellet binder is employed. For example, a pelletization unit may be downstream of the graphite production unit, to receive the biographite and also receive a pellet binder, and to generate biographite pellets. The pellet binder, when present, may be selected from starch, thermoplastic starch, crosslinked starch, starch polymers, cellulose, cellulose ethers, hemicellulose, methylcellulose, chitosan, lignin, lactose, sucrose, dextrose, maltodextrin, banana flour, wheat flour, wheat starch, soy flour, corn flour, wood flour, coal tars, coal fines, met coke, asphalt, coal-tar pitch, petroleum pitch, bitumen, pyrolysis tars, gilsonite, bentonite clay, borax, limestone, lime, waxes, vegetable waxes, baking soda, baking powder, sodium hydroxide, potassium hydroxide, iron ore concentrate, silica fume, gypsum, Portland cement, guar gum, xanthan gum, polyvidones, polyacrylamides, polylactides, phenol-formaldehyde resins, vegetable resins, recycled shingles, recycled tires, recycled cardboard, recycled paper, derivatives thereof, or any combination of the foregoing.

In some embodiments, a pellet binder is selected from starch, thermoplastic starch, crosslinked starch, starch polymers, derivatives thereof, or any combinations of the foregoing. The pellet binder may be a thermoplastic starch that is optionally crosslinked. The thermoplastic starch may be a reaction product of starch and a polyol. The polyol may be selected from ethylene glycol, propylene glycol, glycerol, butanediols, butanetriols, erythritol, xylitol, sorbitol, or a combination thereof. The reaction product may be formed from a reaction that is catalyzed by an acid. The acid may be selected from formic acid, acetic acid, lactic acid, citric acid, oxalic acid, uronic acids, glucuronic acids, or a combination thereof. Alternatively, the reaction product may be formed from a reaction that is catalyzed by a base.

The biographite pellets may have a Hardgrove Grindability Index (HGI) of at least about 30, at least about 40, or at least about 50. In various embodiments, the biographite pellets have a Hardgrove Grindability Index from about 30 to about 100. In various embodiments, the biographite pellets have a Hardgrove Grindability Index of about, at least about, or at most about 20, 30, 40, 50, 60, 70, 80, 90, 100, 110, or 120, including any intervening ranges. ASTM-Standard D 409/D 409M for “Standard Test Method for Grindability of Coal by the Hardgrove-Machine Method” is hereby incorporated by reference herein in its entirety. Unless otherwise indicated, all references in this disclosure to Hardgrove Grindability Index or HGI are in reference to ASTM-Standard D 409/D 409M.

The biographite pellets may have a Pellet Durability Index (PDI) of at least about 80%, at least about 85%, at least about 90%, or at least about 95%. In various embodiments, the pellet have a Pellet Durability Index of about, at least about, or at most about 70%, 75%, 80%, 85%, 90%, 91%, 92%, 93%, 94%, 95%, 96%, 97%, 98%, or 99%, including any intervening ranges. Unless otherwise indicated, all references in this disclosure to Pellet Durability Index are in reference to ISO 17831-1:2015 “Solid biofuels Determination of mechanical durability of pellets and briquettes Part 1: Pellets”, which is hereby incorporated by reference herein in its entirety.

The biographite may contain one or more additives for various purposes, such as for reduced flammability. The calcined biographite product may be characterized as non-self-heating when subjected to a self-heating test according to Manual of Tests and Criteria, Seventh revised edition 2019, United Nations, Page 375, 33.4.6 Test N. 4: “Test method for self-heating substances”, which is hereby incorporated by reference herein.

In various embodiments, the concentration of additives within the biographite may be about, at least about, or at most about, 0, 1, 2, 3, 4, 5, 6, 7, 8, 9, 10, 15, 20, 25, 30, 35, 40, 45 or 50 wt %, including any intervening range. When additives are employed, the additives do not need to be uniformly distributed throughout the biographite composition.

Additives may be introduced at any point in the process. In some embodiments, the additive type and/or concentration are selected to optimize electronic conductivity associated with the biographite. In some embodiments, the additive type and/or concentration are selected to optimize ionic conductivity associated with the biographite. In some embodiments, the additive type and/or concentration are selected to optimize combined electronic-ionic conductivity associated with the biographite. In some embodiments, the additive type and/or concentration are selected to optimize energy content associated with the biographite. In some embodiments, the additive type and/or concentration are selected to optimize bulk density associated with the biographite. In some embodiments, the additive type and/or concentration are selected to optimize hydrophobicity associated with the biographite. In some embodiments, the additive type and/or concentration are selected to optimize pore sizes associated with the biographite. In some embodiments, the additive type and/or concentration are selected to optimize ratios of pore sizes associated with the biographite. In some embodiments, the additive type and/or concentration are selected to optimize surface area associated with the biographite. In some embodiments, the additive type and/or concentration are selected to optimize reactivity associated with the biographite. In some embodiments, the additive type and/or concentration are selected to optimize ion-exchange capacity associated with the biographite. In some embodiments, the additive type and/or concentration are selected to optimize Hardgrove Grindability Index associated with biographite pellets. In some embodiments, the additive type and/or concentration are selected to optimize Pellet Durability Index associated with biographite pellets.

Imaging and spectroscopy may be used to analyze the biographite (whether or not in pellet form), or any process intermediates. Imaging techniques may include, but are not limited to, optical microscopy; dark-field microscopy; scanning electron microscopy (SEM); transmission electron microscopy (TEM); and X-ray tomography (XRT), for example. Spectroscopy techniques may include, but are not limited to, energy dispersive X-ray spectroscopy (EDS), X-ray fluorescence (XRF), infrared (IR) spectroscopy; and nuclear magnetic resonance (NMR) spectroscopy, for example.

### Biomass Pyrolysis

Processes and systems suitable for pyrolyzing a biomass feedstock to generate a biogenic reagent (to be further converted to syngas) will now be further described in detail. References herein to “biocarbon reagent” will be understood, in various instances, as references to biogenic carbon or a biocarbon composition containing biogenic carbon, depending on the context. In the present disclosure, the biogenic reagent may be used in a variety of ways.

“Pyrolysis” and “pyrolyze” generally refer to thermal decomposition of a carbonaceous material. In pyrolysis, less oxygen is present than is required for complete combustion of the material, such as less than 10%, 5%, 1%, 0.5%, 0.1%, or 0.01% of the oxygen (O₂ molar basis) that is required for complete combustion. In some embodiments, pyrolysis is performed in the absence of oxygen.

Exemplary changes that may occur during pyrolysis include any of the following: (i) heat transfer from a heat source increases the temperature inside the feedstock; (ii) the initiation of primary pyrolysis reactions at this higher temperature releases volatiles and forms a char; (iii) the flow of hot volatiles toward cooler solids results in heat transfer between hot volatiles and cooler unpyrolyzed feedstock; (iv) condensation of some of the volatiles in the cooler parts of the feedstock, followed by secondary reactions, can produce tar; (v) autocatalytic secondary pyrolysis reactions proceed while primary pyrolytic reactions simultaneously occur in competition; and (vi) further thermal decomposition, reforming, water-gas shift reactions, free-radical recombination, and/or dehydrations can also occur, which are a function of the residence time, temperature, and pressure profile.

Pyrolysis can at least partially dehydrate a starting feedstock (e.g., lignocellulosic biomass). In various embodiments, pyrolysis removes greater than about 50%, 75%, 90%, 95%, 99%, or more of the water from the starting feedstock.

In some embodiments, a starting biomass feedstock is selected from the softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, almond shells, pecan shells, coconut shells, coffee grounds, food waste, commercial waste, grass pellets, hay pellets, wood pellets, cardboard, paper, paper pulp, paper packaging, paper trimmings, food packaging, construction and/or demolition waste, lignin, animal manure, municipal solid waste, municipal sewage, or a combination thereof. Note that typically a biomass feedstock contains at least carbon, hydrogen, and oxygen.

The biogenic reagent may comprise at least about 50 wt %, at least about 75 wt %, or at least about 90 wt % total carbon. In various embodiments, the biogenic reagent contains about, at least about, or at most about 20, 25, 30, 35, 40, 45, 50, 55, 60, 65, 70, 75, 80, 85, 90, 95, or 99 wt % carbon. The total carbon is fixed carbon plus non-fixed carbon that is present in volatile matter. In some embodiments, component weight percentages are on an absolute basis, which is assumed unless stated otherwise. In other embodiments, component weight percentages are on a moisture-free and ash-free basis.

The pyrolysis conditions may be varied widely, depending on the desired compositions for the biogenic reagent and pyrolysis off-gas, the starting feedstock, the reactor configuration, and other factors.

In some embodiments, multiple reactor zones are designed and operated in a way that optimizes carbon yield and product quality from pyrolysis, while maintaining flexibility and adjustability for feedstock variations and product requirements.

In some non-limiting embodiments, the temperatures and residence times are preferably selected to achieve relatively slow pyrolysis chemistry. The benefit is potentially the substantial preservation of cell walls contained in the biomass structure, which means the final product can retain some, most, or all of the shape and strength of the starting biomass. In order to maximize this potential benefit, it is preferred to utilize apparatus that does not mechanically destroy the cell walls or otherwise convert the biomass particles into small fines. Preferred reactor configurations are discussed following the process description below.

Additionally, if the feedstock is a milled or sized feedstock, such as wood chips or pellets, it may be desirable for the feedstock to be carefully milled or sized. Careful initial treatment will tend to preserve the strength and cell-wall integrity that is present in the native feedstock source (e.g., trees). This can also be important when the final product should retain some, most, or all of the shape and strength of the starting biomass.

In some embodiments, a first zone of a pyrolysis reactor is configured for feeding biomass (or another carbon-containing feedstock) in a manner that does not “shock” the biomass, which would rupture the cell walls and initiate fast decomposition of the solid phase into vapors and gases. This first zone can be thought of as mild pyrolysis.

In some embodiments, a second zone of a pyrolysis reactor is configured as the primary reaction zone, in which preheated biomass undergoes pyrolysis chemistry to release gases and condensable vapors, leaving a significant amount of solid material which is a high-carbon reaction intermediate. Biomass components (primarily cellulose, hemicellulose, and lignin) decompose and create vapors, which escape by penetrating through pores or creating new nanopores. The latter effect contributes to the creation of porosity and surface area.

In some embodiments, a third zone of a pyrolysis reactor is configured for receiving the high-carbon reaction intermediate and cooling down the solids to some extent. Typically, the third zone will be a lower temperature than the second zone. In the third zone, the chemistry and mass transport can be surprisingly complex. Without being limited by any particular theory or proposed mechanisms, it is believed that secondary reactions may occur in the third zone. Essentially, carbon-containing components that are in the gas phase can decompose to form additional fixed carbon and/or become adsorbed onto the carbon. Thus, the final carbonaceous material may not simply be the solid, devolatilized residue of the processing steps, but rather may include additional carbon that has been deposited from the gas phase, such as by decomposition of organic vapors (e.g., tars) that can form carbon.

Certain embodiments extend the concept of additional carbon formation by including a separate unit in which cooled carbon is subjected to an environment including carbon-containing species, to enhance the carbon content of the final product. When the temperature of this unit is below pyrolysis temperatures, the additional carbon is expected to be in the form of adsorbed carbonaceous species, rather than additional fixed carbon.

There are a large number of options as to intermediate input and output (purge or probe) streams of one or more phases present in any particular zone, various mass and energy recycle schemes, various additives that may be introduced anywhere in the process, adjustability of process conditions including both reaction and separation conditions in order to tailor product distributions, and so on. Zone-specific input and output streams enable good process monitoring and control, such as through FTIR sampling and dynamic process adjustments.

Some embodiments do not employ fast pyrolysis, and some embodiments do not employ slow pyrolysis. Surprisingly high-quality carbon materials, including compositions with very high fractions of fixed carbon, may be obtained from the disclosed processes and systems.

In some embodiments, a pyrolysis process for producing a biogenic reagent comprises the following steps:
(a) providing a carbon-containing feedstock comprising biomass;
(b) optionally drying the feedstock to remove at least a portion of moisture contained within the feedstock;
(c) optionally deaerating the feedstock to remove at least a portion of interstitial oxygen, if any, contained with the feedstock;
(d) pyrolyzing the feedstock in the presence of a substantially inert gas phase for at least 10 minutes and with at least one temperature selected from about 250° C. to about 700° C., to generate hot pyrolyzed solids, condensable vapors, and non-condensable gases;
(e) separating at least a portion of the condensable vapors and at least a portion of the non-condensable gases from the hot pyrolyzed solids;
(f) cooling the hot pyrolyzed solids to generate cooled pyrolyzed solids; and
(g) recovering a biogenic reagent comprising at least a portion of the cooled pyrolyzed solids.

“Biomass,” for purposes of this disclosure, shall be construed as any biogenic feedstock or mixture of a biogenic and non-biogenic feedstocks. Elementally, biomass includes at least carbon, hydrogen, and oxygen. The methods and apparatus of the invention can accommodate a wide range of feedstocks of various types, sizes, and moisture contents.

Biomass includes, for example, plant and plant-derived material, vegetation, agricultural waste, forestry waste, wood waste, paper waste, animal-derived waste, poultry-derived waste, and municipal solid waste. In various embodiments of the invention utilizing biomass, the biomass feedstock may include one or more materials selected from: timber harvesting residues, softwood chips, hardwood chips, tree branches, tree stumps, knots, leaves, bark, sawdust, off-spec paper pulp, cellulose, corn, corn stover, wheat straw, rice straw, sugarcane bagasse, switchgrass, miscanthus, animal manure, municipal garbage, municipal sewage, commercial waste, grape pumice, almond shells, pecan shells, coconut shells, coffee grounds, grass pellets, hay pellets, wood pellets, cardboard, paper, carbohydrates, plastic, and cloth. A person of ordinary skill in the art will readily appreciate that the feedstock options are virtually unlimited.

Some embodiments employ carbon-containing feedstocks other than biomass, such as a fossil fuel (e.g., coal or petroleum coke), or any mixtures of biomass and fossil fuels (such as biomass/coal blends). In some embodiments, a feedstock is, or includes, coal, oil shale, crude oil, asphalt, or solids from crude-oil processing (such as petcoke). Feedstocks may include waste tires, recycled plastics, recycled paper, construction waste, deconstruction waste, and other waste or recycled materials. Carbon-containing feedstocks may be transportable by any known means, such as by truck, train, ship, barge, tractor trailer, or any other vehicle or means of conveyance.

Selection of a particular feedstock or feedstocks is not regarded as technically critical, but is carried out in a manner that tends to favor an economical process as well as a low-carbon-intensity, renewable process.

Typically, regardless of the feedstocks chosen, there can be (in some embodiments) screening to remove undesirable materials. The feedstock can optionally be dried prior to processing.

The feedstock employed may be provided or processed into a wide variety of particle sizes or shapes. For example, the feed material may be a fine powder, or a mixture of fine and coarse particles. The feed material may be in the form of large pieces of material, such as wood chips or other forms of wood (e.g., round, cylindrical, square, etc.). In some embodiments, the feed material comprises pellets or other agglomerated forms of particles that have been pressed together or otherwise bound, such as with a binder.

The starting feed material may be provided with a range of moisture levels, as will be appreciated. In some embodiments, the feed material may already be sufficiently dry that it need not be further dried before pyrolysis. Typically, it will be desirable to utilize commercial sources of biomass which will usually contain moisture, and feed the biomass through a drying step before introduction into the pyrolysis reactor. However, in some embodiments a dried feedstock may be utilized.

It is usually desirable to provide a relatively low-oxygen environment in the pyrolysis reactor, such as about, or at most about, 10 mol %, 5 mol %, 4 mol %, 3 mol %, 2 mol %, 1.5 mol %, 1 mol %, 0.5 mol %, 0.2 mol %, 0.1 mol %, 0.05 mol %, 0.02 mol %, or 0.01 mol % O₂ in the gas phase. First, uncontrolled combustion should be avoided in the pyrolysis reactor, for safety reasons. Some amount of total carbon oxidation to CO₂ may occur, and the heat released from the exothermic oxidation may assist the endothermic pyrolysis chemistry. Large amounts of oxidation of carbon, including partial oxidation to syngas, will reduce the carbon yield to solids.

Practically speaking, it can be difficult to achieve a strictly oxygen-free environment in the reactor. This limit can be approached, and in some embodiments, the reactor is substantially free of molecular oxygen in the gas phase. To ensure that little or no oxygen is present in the pyrolysis reactor, it may be desirable to remove air from the feed material before it is introduced to the reactor. There are various ways to remove or reduce air in the feedstock.

In some embodiments, a deaeration unit is utilized in which feedstock, before or after drying, is conveyed in the presence of another gas which can remove adsorbed oxygen and penetrate the feedstock pores to remove oxygen from the pores. Essentially any gas that has lower than 21 vol % O₂ may be employed, at varying effectiveness. In some embodiments, nitrogen is employed. In some embodiments, CO and/or CO₂ is employed. Mixtures may be used, such as a mixture of nitrogen and a small amount of oxygen. Steam may be present in the deaeration gas, although adding significant moisture back to the feed should be avoided. The effluent from the deaeration unit may be purged (to the atmosphere or to an emissions treatment unit) or recycled.

In principle, the effluent (or a portion thereof) from the deaeration unit could be introduced into the pyrolysis reactor itself since the oxygen removed from the solids will now be highly diluted. In this embodiment, it may be advantageous to introduce the deaeration effluent gas to the last zone of the reactor, when it is operated in a countercurrent configuration.

Various types of deaeration units may be employed. If drying it to be performed, it may be preferable to dry and then deaerate since it may be inefficient to scrub soluble oxygen out of the moisture present. In certain embodiments, the drying and deaerating steps are combined into a single unit, or some amount of deaeration is achieved during drying, and so on.

The optionally dried and optionally deaerated feed material is introduced to a pyrolysis reactor or multiple reactors in series or parallel. The feed material may be introduced using any known means, including screw feeders or lock hoppers, for example. In some embodiments, a material feed system incorporates an air knife.

When a single reactor is employed, preferably multiple zones are present. Multiple zones, such as two, three, four, or more zones, can allow for the separate control of temperature, solids residence time, gas residence time, gas composition, flow pattern, and/or pressure in order to adjust the overall process performance.

References to “zones” shall be broadly construed to include regions of space within a single physical unit, physically separate units, or any combination thereof. For a continuous reactor, the demarcation of zones may relate to structure, such as the presence of flights within the reactor or distinct heating elements to provide heat to separate zones. Alternatively, or additionally, the demarcation of zones in a continuous reactor may relate to function, such as distinct temperatures, fluid flow patterns, solid flow patterns, extent of reaction, and so on. In a single batch reactor, “zones” are operating regimes in time, rather than in space. Multiple batch reactors may also be used.

It will be appreciated that there are not necessarily abrupt transitions from one zone to another zone. For example, the boundary between the preheating zone and pyrolysis zone may be somewhat arbitrary; some amount of pyrolysis may take place in a portion of the preheating zone, and some amount of “preheating” may continue to take place in the pyrolysis zone. The temperature profile in the reactor is typically continuous, including at zone boundaries within the reactor.

Some embodiments employ a first zone that is operated under conditions of preheating and/or mild pyrolysis. The temperature of the first zone may be selected from about 150° C. to about 500° C., such as about 300° C. to about 400° C. The temperature of the first zone is preferably not so high as to shock the biomass material which ruptures the cell walls and initiates fast decomposition of the solid phase into vapors and gases.

All references to zone temperatures in this specification should be construed in a non-limiting way to include temperatures that may apply to the bulk solids present, or the gas phase, or the reactor walls (on the process side). It will be understood that there will be a temperature gradient in each zone, both axially and radially, as well as temporally (i.e., following start-up or due to transients). Thus, references to zone temperatures may be references to average temperatures or other effective temperatures that may influence the actual kinetics. Temperatures may be directly measured by thermocouples or other temperature probes, or indirectly measured or estimated by other means.

The second zone, or in general the primary pyrolysis zone, is operated under conditions of pyrolysis or carbonization. The temperature of the second zone may be selected from about 250° C. to about 700° C., such as about, or at least about, or at most about 300° C., 350° C., 400° C., 450° C., 500° C., 550° C., 600° C., or 650° C. Within this zone, preheated biomass undergoes pyrolysis chemistry to release gases and condensable vapors, leaving a significant amount of solid material as a high-carbon reaction intermediate. Biomass components (primarily cellulose, hemicellulose, and lignin) decompose and create vapors, which escape by penetrating through pores or creating new pores. The preferred temperature will at least depend on the residence time of the second zone, as well as the nature of the feedstock and desired product properties.

The third zone, or cooling zone, is operated to cool down the high-carbon reaction intermediate to varying degrees. At a minimum, the temperature of the third zone should be a lower temperature than that of the second zone. The temperature of the third zone may be selected from about 100° C. to about 550° C., such as about 150° C. to about 350° C.

Chemical reactions may continue to occur in the cooling zone. Without being limited by any particular theory, it is believed that secondary pyrolysis reactions may be initiated in the third zone. Carbon-containing components that are in the gas phase can condense (due to the reduced temperature of the third zone). The temperature remains sufficiently high, however, to promote reactions that may form additional fixed carbon from the condensed liquids (secondary pyrolysis) or at least form bonds between adsorbed species and the fixed carbon. One exemplary reaction that may take place is the Boudouard reaction for conversion of carbon monoxide to carbon dioxide plus fixed carbon.

The residence times of the reactor zones may vary. There is an interplay of time and temperature, so that for a desired amount of pyrolysis, higher temperatures may allow for lower reaction times, and vice versa. The residence time in a continuous reactor (zone) is the volume divided by the volumetric flow rate. The residence time in a batch reactor is the batch reaction time, following heating to reaction temperature.

It should be recognized that in multiphase reactors, there are multiple residence times. In the present context, in each zone, there will be a residence time (and residence-time distribution) of both the solids phase and the vapor phase. For a given apparatus employing multiple zones, and with a given throughput, the residence times across the zones will generally be coupled on the solids side, but residence times may be uncoupled on the vapor side when multiple inlet and outlet ports are utilized in individual zones. The solids and vapor residence times are uncoupled.

The solids residence time of the preheating zone may be selected from about 5 min to about 60 min, such as about 10, 20, 30, 40, or 50 min. Depending on the temperature, sufficient time is desired to allow the biomass to reach a desired preheat temperature. The heat-transfer rate, which will depend on the particle type and size, the physical apparatus, and on the heating parameters, will dictate the minimum residence time necessary to allow the solids to reach a desired preheat temperature. Additional time may not be desirable as it would contribute to higher capital cost, unless some amount of mild pyrolysis is intended in the preheating zone.

The solids residence time of the pyrolysis zone may be selected from about 10 min to about 120 min, such as about 20, 30, 40, 50, 60, 70, 80, 90, or 100 min. Depending on the pyrolysis temperature in this zone, there should be sufficient time to allow the carbonization chemistry to take place, following the necessary heat transfer. For times below about 10 min, in order to remove high quantities of non-carbon elements, the temperature would need to be quite high, such as above 700° C. This temperature would promote fast pyrolysis and its generation of vapors and gases derived from the carbon itself, which is to be avoided when the intended product is solid carbon.

In a static system, there would be an equilibrium conversion that could be substantially reached at a certain time. When, as in certain embodiments, vapor is continuously flowing over solids with continuous volatiles removal, the equilibrium constraint may be removed to allow for pyrolysis and devolatilization to continue until reaction rates approach zero. Longer times would not tend to substantially alter the remaining recalcitrant solids.

The solids residence time of the cooling zone may be selected from about 5 min to about 60 min, such as about 10, 20, 30, 40, or 50 min. Depending on the cooling temperature in this zone, there should be sufficient time to allow the carbon solids to cool to the desired temperature. The cooling rate and temperature will dictate the minimum residence time necessary to allow the carbon to be cooled. Additional time may not be desirable, unless some amount of secondary pyrolysis is desired.

As discussed above, the residence time of the vapor phase may be separately selected and controlled. The vapor residence time of the preheating zone may be selected from about 0.1 min to about 15 min, such as about 0.5, 1, 2, 3, 4, 5, 6, 7, 8, 9, or 10 min. The vapor residence time of the pyrolysis zone may be selected from about 0.1 min to about 20 min, such as about 0.5, 1, 2, 3, 4, 5, 6, 7, 8, 9, 10, 11, 12, 13, 14, or 15 min. The vapor residence time of the cooling zone may be selected from about 0.1 min to about 15 min, such as about 0.5, 1, 2, 3, 4, 5, 6, 7, 8, 9, or 10 min. Short vapor residence times promote fast sweeping of volatiles out of the system, while longer vapor residence times promote reactions of components in the vapor phase with the solid phase.

The mode of operation for the reactor, and overall system, may be continuous, semi-continuous, batch, or any combination or variation of these. In some embodiments, the reactor is a continuous, countercurrent reactor in which solids and vapor flow substantially in opposite directions. The reactor may also be operated in batch but with simulated countercurrent flow of vapors, such as by periodically introducing and removing gas phases from the batch vessel.

Various flow patterns may be desired or observed. With chemical reactions and simultaneous separations involving multiple phases in multiple reactor zones, the fluid dynamics can be quite complex. Typically, the flow of solids may approach plug flow (well-mixed in the radial dimension) while the flow of vapor may approach fully mixed flow (fast transport in both radial and axial dimensions). Multiple inlet and outlet ports for vapor may contribute to overall mixing.

The pressure in each zone may be separately selected and controlled. The pressure of each zone may be independently selected from about 1 kPa to about 3000 kPa, such as about 101.3 kPa (normal atmospheric pressure). Independent zone control of pressure is possible when multiple gas inlets and outlets are used, including vacuum ports to withdraw gas when a zone pressure less than atmospheric is desired.

The process may conveniently be operated at atmospheric pressure, in some embodiments. There are many advantages associated with operation at atmospheric pressure, ranging from mechanical simplicity to enhanced safety. In certain embodiments, the pyrolysis zone is operated at a pressure of about 90 kPa, 95 kPa, 100 kPa, 101 kPa, 102 kPa, 105 kPa, or 110 kPa (absolute pressures).

Vacuum operation (e.g., 10-100 kPa) would promote fast sweeping of volatiles out of the system. Higher pressures (e.g., 100-1000 kPa) may be useful when the off-gases will be fed to a high-pressure operation. Elevated pressures may also be useful to promote heat transfer, chemistry, or separations.

The step of separating at least a portion of the condensable vapors and at least a portion of the non-condensable gases from the hot pyrolyzed solids may be accomplished in the reactor itself, or using a distinct separation unit. A substantially inert sweep gas may be introduced into one or more of the zones. Condensable vapors and non-condensable gases are then carried away from the zone(s) in the sweep gas, and out of the reactor.

The sweep gas may be N₂, Ar, CO, CO₂, H₂, H₂O, CH₄, other light hydrocarbons, or combinations thereof, for example. The sweep gas may first be preheated prior to introduction, or possibly cooled if it is obtained from a heated source.

The sweep gas more thoroughly removes volatile components, by getting them out of the system before they can condense or further react. The sweep gas allows volatiles to be removed at higher rates than would be attained merely from volatilization at a given process temperature. Or, use of the sweep gas allows milder temperatures to be used to remove a certain quantity of volatiles. The reason the sweep gas improves the volatiles removal is that the mechanism of separation is not merely relative volatility but rather liquid/vapor phase disengagement assisted by the sweep gas. The sweep gas can both reduce mass-transfer limitations of volatilization as well as reduce thermodynamic limitations by continuously depleting a given volatile species, to cause more of it to vaporize in order to attain thermodynamic equilibrium.

Some embodiments remove gases laden with volatile organic carbon from subsequent processing stages, in order to produce a product with high fixed carbon. Without removal, the volatile carbon can adsorb or absorb onto the pyrolyzed solids, thereby requiring additional energy (cost) to achieve a purer form of carbon which may be desired. By removing vapors quickly, it is also speculated that porosity may be enhanced in the pyrolyzing solids. Higher porosity is desirable for some products.

In certain embodiments, the sweep gas in conjunction with a relatively low process pressure, such as atmospheric pressure, provides for fast vapor removal without large amounts of inert gas necessary.

In some embodiments, the sweep gas flows countercurrent to the flow direction of feedstock. In other embodiments, the sweep gas flows co-current to the flow direction of feedstock. In some embodiments, the flow pattern of solids approaches plug flow while the flow pattern of the sweep gas, and gas phase generally, approaches fully mixed flow in one or more zones.

The sweep may be performed in any one or more of the reactor zones. In some embodiments, the sweep gas is introduced into the cooling zone and extracted (along with volatiles produced) from the cooling and/or pyrolysis zones. In some embodiments, the sweep gas is introduced into the pyrolysis zone and extracted from the pyrolysis and/or preheating zones. In some embodiments, the sweep gas is introduced into the preheating zone and extracted from the pyrolysis zone. In these or other embodiments, the sweep gas may be introduced into each of the preheating, pyrolysis, and cooling zones and also extracted from each of the zones.

In some embodiments, the zone or zones in which separation is carried out is a physically separate unit from the reactor. The separation unit or zone may be disposed between reactor zones, if desired. For example, there may be a separation unit placed between pyrolysis and cooling units.

The sweep gas may be introduced continuously, especially when the solids flow is continuous. When the pyrolysis reaction is operated as a batch process, the sweep gas may be introduced after a certain amount of time, or periodically, to remove volatiles. Even when the pyrolysis reaction is operated continuously, the sweep gas may be introduced semi-continuously or periodically, if desired, with suitable valves and controls.

The volatiles-containing sweep gas may exit from the one or more reactor zones, and may be combined if obtained from multiple zones. The resulting gas stream, containing various vapors, may then be fed to a thermal oxidizer for control of air emissions. Any known thermal-oxidation unit may be employed. In some embodiments, the thermal oxidizer is fed with natural gas and air, to reach sufficient temperatures for substantial destruction of volatiles contained therein.

The effluent of the thermal oxidizer will be a hot gas stream comprising water, carbon dioxide, and nitrogen. This effluent stream may be purged directly to air emissions, if desired. Preferably, the energy content of the thermal oxidizer effluent is recovered, such as in a waste-heat recovery unit. The energy content may also be recovered by heat exchange with another stream (such as the sweep gas). The energy content may be utilized by directly or indirectly heating, or assisting with heating, a unit elsewhere in the process, such as the dryer or the reactor. In some embodiments, essentially all of the thermal oxidizer effluent is employed for indirect heating (utility side) of the dryer. The thermal oxidizer may employ other fuels than natural gas.

The yield of carbonaceous material may vary, depending on the above-described factors including type of feedstock and process conditions. In some embodiments, the net yield of solids as a percentage of the starting feedstock, on a dry basis, is at least 25%, 30%, 35%, 40%, 45%, 50%, or higher. The remainder will be split between condensable vapors, such as terpenes, tars, alcohols, acids, aldehydes, or ketones; and non-condensable gases, such as carbon monoxide, hydrogen, carbon dioxide, and methane. The relative amounts of condensable vapors compared to non-condensable gases will also depend on process conditions, including the water present.

In terms of the carbon balance, in some embodiments the net yield of carbon as a percentage of starting carbon in the feedstock is at least 25%, 30%, 40%, 50%, 60%, 65%, 70%, 75%, 80%, or higher. For example, the in some embodiments the carbonaceous material contains between about 40% and about 70% of the carbon contained in the starting feedstock. The rest of the carbon results in the formation of methane, carbon monoxide, carbon dioxide, light hydrocarbons, aromatics, tars, terpenes, alcohols, acids, aldehydes, or ketones, to varying extents.

In alternative embodiments, some portion of these compounds is combined with the carbon-rich solids to enrich the carbon and energy content of the product. In these embodiments, some or all of the resulting gas stream from the reactor, containing various vapors, may be condensed, at least in part, and then passed over cooled pyrolyzed solids derived from the cooling zone and/or from the separate cooling unit. These embodiments are described in more detail below.

Following the reaction and cooling within the cooling zone (if present), the carbonaceous solids may be introduced into a distinct cooling unit. In some embodiments, solids are collected and simply allowed to cool at slow rates. If the carbonaceous solids are reactive or unstable in air, it may be desirable to maintain an inert atmosphere and/or rapidly cool the solids to, for example, a temperature less than 40° C., such as ambient temperature. In some embodiments, a water quench is employed for rapid cooling. In some embodiments, a fluidized-bed cooler is employed. A “cooling unit” should be broadly construed to also include containers, tanks, pipes, or portions thereof.

In some embodiments, the process further comprises operating the cooling unit to cool the warm pyrolyzed solids with steam, thereby generating the cool pyrolyzed solids and superheated steam; wherein the drying is carried out, at least in part, with the superheated steam derived from the cooling unit. Optionally, the cooling unit may be operated to first cool the warm pyrolyzed solids with steam to reach a first cooling-unit temperature, and then with air to reach a second cooling-unit temperature, wherein the second cooling-unit temperature is lower than the first cooling-unit temperature and is associated with a reduced combustion risk for the warm pyrolyzed solids in the presence of the air.

Following cooling to ambient conditions, the carbonaceous solids may be recovered and stored, conveyed to another site operation, transported to another site, or otherwise disposed, traded, or sold. The solids may be fed to a unit to reduce particle size. A variety of size-reduction units are known in the art, including crushers, shredders, grinders, pulverizers, jet mills, pin mills, and ball mills.

Screening or some other means for separation based on particle size may be included. The grinding may be upstream or downstream of grinding, if present. A portion of the screened material (e.g., large chunks) may be returned to the grinding unit. The small and large particles may be recovered for separate downstream uses. In some embodiments, cooled pyrolyzed solids are ground into a fine powder, such as a pulverized carbon or activated carbon product.

Various additives may be introduced throughout the process, before, during, or after any step disclosed herein. The additives may be broadly classified as process additives, selected to improve process performance such as carbon yield or pyrolysis time/temperature to achieve a desired carbon purity; and product additives, selected to improve one or more properties of the biogenic reagent, or a downstream product incorporating the reagent. Certain additives may provide enhanced process and product (biogenic reagents or products containing biogenic reagents) characteristics.

Additives may be added before, during, or after any one or more steps of the process, including into the feedstock itself at any time, before or after it is harvested. Additive treatment may be incorporated prior to, during, or after feedstock sizing, drying, or other preparation. Additives may be incorporated at or on feedstock supply facilities, transport trucks, unloading equipment, storage bins, conveyors (including open or closed conveyors), dryers, process heaters, or any other units. Additives may be added anywhere into the pyrolysis process itself, using suitable means for introducing additives. Additives may be added after carbonization, or even after pulverization, if desired.

In some embodiments, an additive is selected from a metal, a metal oxide, a metal hydroxide, or a combination thereof. For example an additive may be selected from, but is by no means limited to, magnesium, manganese, aluminum, nickel, chromium, silicon, boron, cerium, molybdenum, phosphorus, tungsten, vanadium, iron chloride, iron bromide, magnesium oxide, dolomite, dolomitic lime, fluorite, fluorospar, bentonite, calcium oxide, lime, and combinations thereof.

In some embodiments, an additive is selected from an acid, a base, or a salt thereof. For example an additive may be selected from, but is by no means limited to, sodium hydroxide, potassium hydroxide, magnesium oxide, hydrogen bromide, hydrogen chloride, sodium silicate, potassium permanganate, or combinations thereof.

In some embodiments, an additive is selected from a metal halide. Metal halides are compounds between metals and halogens (fluorine, chlorine, bromine, iodine, and astatine). The halogens can form many compounds with metals. Metal halides are generally obtained by direct combination, or more commonly, neutralization of basic metal salt with a hydrohalic acid. In some embodiments, an additive is selected from iron chloride (FeCl₂ and/or FeCl₃), iron bromide (FeBr₂ and/or FeBr₃), or hydrates thereof, and any combinations thereof.

Additives may result in a final product with higher energy content (energy density). An increase in energy content may result from an increase in total carbon, fixed carbon, volatile carbon, or even hydrogen. Alternatively or additionally, the increase in energy content may result from removal of non-combustible matter or of material having lower energy density than carbon. In some embodiments, additives reduce the extent of liquid formation, in favor of solid and gas formation, or in favor of solid formation.

Without being limited to any particular hypothesis, additives may chemically modify the starting biomass, or treated biomass prior to pyrolysis, to reduce rupture of cell walls for greater strength/integrity. In some embodiments, additives may increase fixed carbon content of biomass feedstock prior to pyrolysis.

Additives may result in a biogenic reagent with improved mechanical properties, such as yield strength, compressive strength, tensile strength, fatigue strength, impact strength, elastic modulus, bulk modulus, or shear modulus. Additives may improve mechanical properties by simply being present (e.g., the additive itself imparts strength to the mixture) or due to some transformation that takes place within the additive phase or within the resulting mixture. For example, reactions such as vitrification may occur within a portion of the biogenic reagent that includes the additive, thereby improving the final strength.

Chemical additives may be applied to wet or dry biomass feedstocks. The additives may be applied as a solid powder, a spray, a mist, a liquid, or a vapor. In some embodiments, additives may be introduced through spraying of a liquid solution (such as an aqueous solution or in a solvent), or by soaking in tanks, bins, bags, or other containers.

In certain embodiments, dip pretreatment is employed wherein the solid feedstock is dipped into a bath comprising the additive, either batchwise or continuously, for a time sufficient to allow penetration of the additive into the solid feed material.

In some embodiments, additives applied to the feedstock may reduce energy requirements for the pyrolysis, and/or increase the yield of the carbonaceous product. In these or other embodiments, additives applied to the feedstock may provide functionality that is desired for the intended use of the carbonaceous product.

The throughput, or process capacity, may vary widely from small laboratory-scale units to full operations, including any pilot, demonstration, or semi-commercial scale. In various embodiments, the process capacity (for feedstocks, products, or both) is at least about 1 kg/day, 10 kg/day, 100 kg/day, 1 ton/day (all tons are metric tons), 10 tons/day, 100 tons/day, 500 tons/day, 1000 tons/day, 2000 tons/day, or higher.

In some embodiments, a portion of solids produced may be recycled to the front end of the process, i.e. to the drying or deaeration unit or directly to the reactor. By returning to the front end and passing through the process again, treated solids may become higher in fixed carbon. Solid, liquid, and gas streams produced or existing within the process can be independently recycled, passed to subsequent steps, or removed/purged from the process at any point.

In some embodiments, pyrolyzed material is recovered and then fed to a separate unit for further pyrolysis, to create a product with higher carbon purity (e.g., conversion of low-fixed-carbon material to high-fixed-carbon material). In some embodiments, the secondary process may be conducted in a simple container, such as a steel drum, in which heated inert gas (such as heated N₂) is passed through. Other containers useful for this purpose include process tanks, barrels, bins, totes, sacks, and roll-offs. This secondary sweep gas with volatiles may be sent to the thermal oxidizer, or back to the main process reactor, for example. To cool the final product, another stream of inert gas, which is initially at ambient temperature for example, may be passed through the solids to cool the solids, and then returned to an inert gas preheat system.

In this detailed description, reference has been made to multiple embodiments of the invention and non-limiting examples relating to how the invention can be understood and practiced. Other embodiments that do not provide all of the features and advantages set forth herein may be utilized, without departing from the spirit and scope of the present invention. This invention incorporates routine experimentation and optimization of the methods and systems described herein. Such modifications and variations are considered to be within the scope of the invention defined by the claims.

All publications, patents, and patent applications cited in this specification are herein incorporated by reference in their entirety as if each publication, patent, or patent application were specifically and individually put forth herein.

Where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially. Therefore, to the extent there are variations of the invention, which are within the spirit of the disclosure or equivalent to the inventions found in the appended claims, it is the intent that this patent will cover those variations as well. The present invention shall only be limited by what is claimed.

What is claimed is:

1. A process for producing biographite from biomass, said process comprising:
(a) converting a biomass feedstock into at least a syngas stream, wherein said syngas stream contains CO, CO₂, H₂, optionally H₂O, and optionally CH₄;
(b) providing a catalytic-metal structure comprising an aromatization catalyst that enhances formation of aromatic carbon from adsorbed vapor-phase carbon-containing species;
(c) placing said catalytic-metal structure into an internal volume of a syngas-deposition reactor;
(d) feeding said syngas stream into said syngas-deposition reactor, wherein said syngas-deposition reactor contains less than 0.1 wt % O₂ and less than 10 wt % H₂O based on all reactor contents, wherein said syngas-deposition reactor is operated at a syngas-deposition temperature from about 500° C. to about 1200° C., and wherein carbon contained in said CO deposits onto said catalytic-metal structure to form fused aromatic rings on the surface of said catalytic-metal structure, thereby forming a carbon-coated catalytic-metal structure;
(e) retrieving said carbon-coated catalytic-metal structure from said syngas-deposition reactor;
(f) recovering graphite-precursor carbon from said carbon-coated catalytic-metal structure, thereby generating a spent catalytic-metal structure;
(g) thermally treating said graphite-precursor carbon to generate crystalline graphite; and
(h) recovering said crystalline graphite as a biographite product.

2. The process of claim 1, wherein step (a) utilizes biomass pyrolysis, biomass gasification, biomass plasma treatment, or a combination thereof, to generate said syngas stream.

3. The process of claim 1, wherein said biomass feedstock is raw biomass.

4. The process of claim 1, wherein said biomass feedstock is pyrolyzed biomass.

5. The process of claim 1, wherein said process further comprises subjecting said syngas stream to a water-gas shift reaction to adjust the H₂/CO ratio of said syngas stream.

6. The process of claim 5, wherein said water-gas shift reaction is carried out to reduce said H₂/CO ratio of said syngas stream.

7. The process of claim 1, wherein said aromatization catalyst contains a metal selected from Fe, Cu, Ni, Co, Mo, or a combination thereof.

8. The process of claim 1, wherein said aromatization catalyst contains a metal oxide selected from iron oxides, copper oxides, nickel oxides, cobalt oxides, molybdenum oxides, silicon oxides, aluminum oxides, or a combination thereof.

9. The process of claim 1, wherein said catalytic-metal structure is surface-activated prior to step (c) using an acid wash, a base wash, or a combination thereof, optionally followed by drying.

10. The process of claim 1, wherein said catalytic-metal structure is seeded prior to step (c).

11. The process of claim 10, wherein said catalytic-metal structure is seeded with a bioliquid film disposed on said surface of said catalytic-metal structure.

12. The process of claim 10, wherein said catalytic-metal structure is seeded with an aromatics film disposed on said surface of said catalytic-metal structure.

13. The process of claim 1, wherein following step (f), said spent catalytic-metal structure is cleaned and then reused in step (c) as said catalytic-metal structure placed back into said syngas-deposition reactor.

14. The process of claim 1, wherein said syngas stream contains CH₄, and wherein carbon contained in said CH₄ also deposits onto said catalytic-metal structure to form said fused aromatic rings on said surface of said catalytic-metal structure.

15. The process of claim 1, wherein carbon contained in said CO₂ also deposits onto said catalytic-metal structure.

16. The process of claim 1, wherein said biographite product contains at least 80 wt % total carbon.

17. The process of claim 1, wherein said biographite product contains less than 10 wt % of metals, metal alloys, metal oxides, metal carbides, metal nitrides, and/or metal hydrides.

18. The process of claim 1, wherein said biographite product is 100% renewable, according to a measurement of the ¹⁴C/¹²C isotopic ratio of the renewable biographite product.

19. The process of claim 1, wherein said biographite product contains at least 50 wt % crystalline graphite according to spectroscopy.

20. The process of claim 1, wherein said process further comprises fabricating an electrode containing the biographite product.
